(19) United States
(12) Patent Application Publication
(10) Pub. No.: US 2008/0062355 A1
(43) Pub. Date: Mar. 13, 2008

(54) Polarizing Plate and Liquid Crystal Display

(75) Inventors: Hiroaki Sata, Minami-Ashigara-shi (JP); Yosuke Nishiura, Odawara-shi (JP); Takako Nishiura, Odawara-shi (JP); Tadashi Ito, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., KANAGAWA (JP)

(21) Appl. No.: 10/584,462

(22) PCT Filed: Dec. 21, 2004
(86) PCT No.: PCT/JP04/19656

§ 371 Date: Apr. 6, 2007

(30) Foreign Application Priority Data
Dec. 25, 2003 (JP) 2003-430718
Jul. 21, 2004 (JP) 2004-213205

(51) Int. Cl. G02F 1/1335; C09K 19/00; G02B 5/30

(52) U.S. Cl. 349/96; 349/187; 359/500; 428/1.31

(57) ABSTRACT

To provide a polarizing plate which has superior characteristics of expressing in-plane and thicknesswise retardation and which is less susceptible to time-varying changes in retardation value attributable to ambient humidity, as well as to provide a liquid crystal display which undergoes little tune-varying change in view angle characteristic, the polarizing plate which contains a transparent protective film having the retardation specified in the specification is housed in a moisture-proofed container under the humidity condition specified in the specification, and the liquid crystal display contains the polarizing plate.

### TECHNICAL FIELD

The present invention relates to a polarizing plate using a cellulose acylate film as a protective film, as well as to a liquid crystal display equipped with the polarizing plate.

### BACKGROUND ART

A liquid crystal display has various advantages, including an ability to achieve miniaturization and reduction in thickness, and to be driven at low voltage and low power consumption. Because of these advantages, the liquid crystal display has been widely utilized in applications; i.e., a monitor of a personal computer or portable equipment, and a television set. Various modes have been proposed for such a liquid crystal display according to an arrangement of liquid crystal in a liquid crystal cell. A TN mode has hitherto been mainstream, wherein the liquid crystal is twisted through about 90° from a lower substrate to an upper substrate of the liquid crystal cell.

The liquid crystal display usually contains a liquid crystal cell, an optical compensation sheet, and a polarizer. The optical compensation sheet is used for preventing coloring of an image or increasing a view angle. A film made by applying a liquid crystal over an drawn birefringent film or a transparent film is used for the optical compensation sheet. For instance, Japanese Patent No. 2587398 describes a technique for applying a discotic liquid crystal on a triacetylcellulose film to thus prepare an optical compensation sheet having an oriented, fixed the liquid crystal and applying the optical compensation sheet to a liquid crystal cell of TN mode, thereby broadening a view angle.

However, a strict demand for view angle dependency exists in connection with a liquid crystal display for use in a television set whose large-size screen is assumed to be viewed from various angles, and the previously-described technique cannot fulfill the demand. For this reason, liquid crystal displays having modes different from the TN mode; that is, an IPS (In-Plane Switching) mode, an OCB (Optically Compensatory Bend) mode, and a VA (Vertically-Aligned) mode, etc., have been studied. Especially, the VA mode yields high contrast and provides a comparatively-high manufacturing yield. For this reason, attention is paid to the VA mode as a mode of the liquid crystal display for use in a TV set.

The acylate cellulose film is characterized by high optical isotropy (i.e., a low retardation value) in contrast with another polymer film. Consequently, the cellulose acetate film is commonly used in an application requiring optical isotropy; e.g., a polarizing plate.

In contrast, optical anisotropy (i.e., a high retardation value) is required of the optical compensation sheet (a phase difference film) of the liquid crystal display. Particularly, the optical compensation sheet requires an in-plane retardation (Re) of 30 to 200 nm and a thicknesswise retardation (Rth) of 70 to 400 nm. Accordingly, a synthetic polymer film having a high retardation value, such as a polycarbonate film or a polysulfone film, is usually used as the optical compensation sheet. The thicknesswise retardation value and the in-plane retardation value are optical properties computed according to the following formulas:

Re=(nx−ny)×d

Rth={(nx+ny)/2−nz}×d

wherein nx is a refractive index in a direction “x” within a plane of a film; ny is a refractive index in direction “y” within the plane of the film; nz is a refractive index in the direction orthogonal to the film plane; and “d” is the thickness of the film (μm).

As mentioned above, in the field of optical films, when the polymer film requires optical isotropy (low retardation value), the synthetic polymer film is usually used. In contrast, when optical anisotropy (high retardation value) is required, the cellulose acetate film is usually used.

EP 0911656 A2 describes a cellulose acetate film which can be used in an application requiring optical anisotropy by disproving the conventional general principle and has a high retardation value. In EP 0911656 A2, in order to achieve a high retardation value by a cellulose triacetate, an aromatic compound having at least two aromatic rings; in particular, 1,3,5-triazine rings, is added to the cellulose triacetate, and the resultant compound is subjected to drawing treatment. The cellulose triacetate is generally a hard-to-draw polymer material and is known to encounter difficulty in increasing birefringence. However, birefringence can be increased by simultaneously orienting an additive through the drawing treatment, thereby attaining a high retardation value. This film can double as a protective film of a polarizing plate, and hence there is yielded an advantage of an ability to provide an inexpensive thin-film liquid crystal display.

JP-A-2002-71957 describes an optical film that has an acyl group having 2 to 4 carbons as a substituent. Given that a substitution degree of an acetyl group is A and that a substitution degree of a propionyl or butyryl group is B, the optical film contains a cellulose ester simultaneously satisfying 2.0≦A+B≦3.0 and A<2.4. The optical film is characterized in that a refractive index Nx in a direction of a slow axis at a wavelength of 590 nm and a refractive index Ny in a direction of a fast axis satisfy 0.0005≦Nx−Ny≦0.0050.

JP-A-2002-270442 describes a polarizing plate for use in a VA-mode liquid crystal display. The polarizing plate is characterized by having a polarizer and an optically-biaxial mixed fatty acid cellulose ester film, wherein the optically-biaxial mixed fatty acid cellulose ester film is interposed between a liquid crystal cell and the polarizer.

The above-mentioned method is effective in producing an inexpensive, thin liquid crystal display. However, the liquid crystal display has recently come to be used under various environments, and there arises a problem of the optical compensation function of the cellulose acetate film changing according to the environment. Especially, there exists a problem of the cellulose acetate film being influenced by changes in environment, particularly, changes in humidity, when the cellulose acetate film is stuck to the liquid crystal cell, whereupon the Re retardation value and the Rth retardation value of the cellulose acetate film vary, to thus change the optical compensation function. Resolution of this problem has been desired.

### DISCLOSURE OF THE INVENTION

An object of the present invention is to provide a polarizing plate which has superior characteristics of expressing in-plane and thicknesswise retardation and which is less susceptible to time-varying changes in retardation value attributable to ambient humidity.

Another object of the present invention is to provide a liquid crystal display which undergoes few time-varying changes in view angle characteristic.

The above objects of the present invention are attained by a polarizing plate and liquid crystal display, which are provided below.

1. A polarizing plate housed in a moisture-proofed container, which comprises

a transparent protective film comprising a cellulose acylate film, wherein Re(λ) and Rth(λ) defined by formulae (I) and (II) satisfies formulae (III) and (IV),

wherein

a humidity in the moisture-proofed container is from 40% RH to 65% RH at 25° C.:

Re(λ)=(nx−ny)×d (I)

Rth(λ)={(nx+ny)/2−nz}×d (II)

30≦Re(590)≦200 (III)

70≦Rth(590)≦400 (IV)

wherein Re(λ) is a retardation value by nm in a film plane of the cellulose acylate film with respect to a light having a wavelength of λ nm;

Rth(λ) is a retardation value by nm in a direction of thickness of the cellulose acylate film with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

2. A polarizing plate housed in a moisture-proofed container, which comprises

a transparent protective film comprising a cellulose acylate film, wherein Re(λ) and Rth(λ) defined by formulae (I) and (II) satisfies formulae (III) and (IV),

wherein

a first humidity in the moisture-proofed container is within a range of ±15% RH with respect to a second humidity, when the polarizing plate is stuck to a liquid crystal cell at the second humidity:

Re(λ)=(nx−ny)×d (I)

Rth(λ)={(nx+ny)/2−nz}×d (II)

30≦Re(590)≦200 (III)

70≦Rth(590)≦400 (IV)

wherein Re(λ) is a retardation value by nm in a film plane of the cellulose acylate film with respect to a light having a wavelength of λ nm;

Rth(λ) is a retardation value by nm in a direction perpendicular the film plane with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

3. The polarizing plate according to item 1 or 2, wherein the cellulose acylate film satisfies formula (V):

230≦Rth(590)≦300. (V)

4. The polarizing plate according to any one of items 1 to 3, wherein

the cellulose acylate film comprises a cellulose acylate in which a hydroxyl group of a cellulose is substituted by at least one of an acetyl group and an acyl group having 3 to 22 carbon atoms; and

a substitution degree A of the acetyl group and a substitution degree B of the acyl group having 3 to 22 carbon atoms satisfy formula (VI):

2.0≦A+B≦3.0. (VI)

5. The polarizing plate according to item 4, wherein the acyl group having 3 to 22 carbon atoms comprises at least one of a butanoyl group and a propionyl group.

6. The polarizing plate according to any one of items 1 to 5, wherein the cellulose acylate film comprises a cellulose acylate in which a total substitution degree of a hydroxyl group at sixth position of a cellulose is 0.75 or more.

7. The polarizing plate according to any one of items 1 to 6, wherein the cellulose acylate film comprises a retardation-developing agent comprising at least one of a rod-like compound and a discotic compound.

8. The polarizing plate according to any one of items 1 to 7, wherein the cellulose acylate film comprises at least one of a plasticizer, an ultraviolet absorber, and a parting agent.

9. The polarizing plate according to any one of items 1 to 8, wherein the cellulose acylate film has a thickness of 40 to 110 μm.

10. The polarizing plate according to any one of items 1 to 9, wherein the cellulose acylate film has a glass transition temperature Tg of 70 to 135° C.

11. The polarizing plate according to any one of items 1 to 10, wherein the cellulose acylate film has an elastic modulus of 1500 to 5000 MPa.

12. The polarizing plate according to any one of items 1 to 11, wherein the cellulose acylate film has an equilibrium moisture content of 3.2% or less at 25° C. and 80% RH.

13. The polarizing plate according to any one of items 1 to 12, wherein the cellulose acylate film has a water vapor permeability of 300 g/m²·24 hr to 1000 g/m²·24 hr in terms of a film thickness of 80 μm under a condition of 40° C. and 90% RH for 24 hours.

14. The polarizing plate according to any one of items 1 to 13, wherein the cellulose acylate film has a haze of 0.01 to 2%.

15. The polarizing plate according to any one of items 1 to 14, wherein the cellulose acylate film comprises a silicon dioxide particle having an average secondary particle size of 0.2 to 1.5 μm.

16. The polarizing plate according to any one of items 1 to 15, wherein the cellulose acylate film has a photoelastic coefficient of 50×10⁻¹³ cm²/dyne or less.

17. The polarizing plate according to any one of items 1 to 16, which comprises at least one of a hard coating layer, an antiglare layer.

18. A liquid crystal display comprising a polarizing plate according to any one of items 1 to 17.

19. A liquid crystal display comprising:

a liquid crystal cell of an OCB-mode or a VA-mode; and

a polarizing plate according to any one of items 1 to 17 on each of upper and lower sides of the liquid crystal cell.

20. A liquid crystal display comprising:

a liquid crystal cell of a VA-mode;

a back light; and

a polarizing plate according to any one of items 1 to 17 between the liquid crystal cell and the back light.

21. A moisture-proofed container housing a polarizing plate, which has a internal humidity of 40% RH to 65% RH at 25° C.,

wherein the polarizing plate comprises a transparent protective film comprising a cellulose acylate film, wherein Re(λ) and Rth(λ) defined by formulae (I) and (II) satisfies formulae (III) and (IV):

Re(λ)=(nx−ny)×d (I)

Rth(λ)={(nx+ny)/2−nz}×d (II)

30≦Re(590)≦200 (III)

70≦Rth(590)≦400 (IV)

wherein Re(λ) is a retardation value by nm in a film plane of the cellulose acylate film with respect to a light having a wavelength of λ nm;

Rth(λ) is a retardation value by nm in a direction of thickness of the cellulose acylate film with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

22. The moisture-proofed container according to item 21, which comprises a material having a water vapor permeability of 30 g/m²·24 hr or less under a condition of 40° C. and 90% RH for 24 hours.

23. The moisture-proofed container according to item 21, which comprises a plastic film having a ceramics layer.

24. The moisture-proofed container according to item 21, which comprises a plastic film and an aluminum foil.

25. A method for storing a polarizing plate, which comprises housing the polarizing plate in a moisture-proofed container having a internal humidity of 40% RH to 65% RH at 25° C.,

wherein the polarizing plate comprises a transparent protective film comprising a cellulose acylate film, wherein Re(λ) and Rth(λ) defined by formulae (I) and (II) satisfies formulae (III) and (IV):

Re(λ)=(nx−ny)×d (I)

Rth(λ)={(nx+ny)/2−nz}×d (II)

30≦Re(590)≦200 (III)

70≦Rth(590)≦400 (IV)

wherein Re(λ) is a retardation value by nm in a film plane of the cellulose acylate film with respect to a light having a wavelength of λ nm;

Rth(λ) is a retardation value by nm in a direction of thickness of the cellulose acylate film with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

26. A method for producing a liquid crystal display, which comprises:

storing a polarizing plate at a first humidity; and

sticking the polarizing plate to a liquid crystal cell at a second humidity,

wherein

the first humidity is within a range of ±15% RH with respect to the second humidity; and

the polarizing plate comprises a transparent protective film comprising a cellulose acylate film, wherein Re(λ) and Rth(λ) defined by formulae (I) and (II) satisfies formulae (III) and (IV):

Re(λ)=(nx−ny)×d (I)

Rth(λ)={(nx+ny)/2−nz}×d (II)

30≦Re(590)≦200 (III)

70≦Rth(590)≦400 (IV)

wherein Re(λ) is a retardation value by nm in a film plane of the cellulose acylate film with respect to a light having a wavelength of λ nm;

Rth(λ) is a retardation value by nm in a direction of thickness of the cellulose acylate film with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

### ADVANTAGES OF THE INVENTION

The polarizing plate of the present invention is superior characteristics of expressing in-plane and thicknesswise retardation and less susceptible to time-varying changes in retardation value attributable to ambient humidity.

The liquid crystal display of the present invention has the polarizing plate and is less susceptible to changes in view-angle characteristic.

### DETAILED DESCRIPTION OF THE INVENTION

The polarizing plate of the present invention is housed in a moisture-proofed container, and a humidity of the moisture-proofed container, when the polarizing plate is housed therein,
(i) is within the range of 40% RH to 65% RH at 25° C.: or
(ii) is within a range of ±15% RH with respect to a humidity achieved when the polarizing plate of the present invention is stuck to a liquid crystal cell.

At least one of transparent protective films used in the polarizing plate comprises a cellulose acylate film whose Re(λ) and Rth(λ) defined by the previously-described formulae (I) and (II) satisfy the previously-described formulae (III) and (IV).

The cellulose acylate film serving as a transparent protective film used in the polarizing plate of the present invention will now be described in more detail.

### (Cellulose Acylate)

Insofar as the advantage of the present invention is concerned, no specific limitations are imposed on the cellulose acylate of the present invention. Two or more different types of cellulose acylates may be used in a mixed manner in the present invention. Of these cellulose acylates, the following materials can be provided as preferable cellulose acylates. Specifically, a cellulose acylate whose substitution degree of a hydroxyl group of a cellulose satisfies

2.0≦A+B≦3.0, formula (VI)

wherein A and B denote degrees of substitution of an acyl group substituted by the hydroxyl group of the cellulose; A denotes a substitution degree of an acetyl group; and B denotes a substitution degree of the acyl group having 3 to 22 carbon atoms.

The glucose unit constituting cellulose and having β-1,4 binding has a free hydroxyl group at the second, third, and sixth positions. The cellulose acylate is a polymer made by esterifying a portion or the entirety of the hydroxyl group with the acyl group. The substitution degree of the acyl group signifies the ratio of esterification of ester (100% esterification corresponds to a substitution degree of 1) at each of the second, third, and sixth positions. In the present invention, a total of a substitution degree A of a hydroxy group by an acetyl group and a substitution degree B by an acyl group having 3 to 22 carbon atoms preferably falls within the range of 2.2 to 2.86, more preferably 2.40 to 2.80. The substitution degree B is preferably 1.50 or more, and more preferably 1.7 or more. The substitution degree of the sixth hydroxy group is preferably 28% or more of the substitution degree B, more preferably 30% or more of the same, further preferably 31% or more of the same, and particularly preferably 32% or more of the same. In connection with the sixth hydroxy group, a total of substitution degrees A and B of the cellulose acylate is preferably 0.75 or more, more preferably 0.80 or more, and particularly preferably 0.85 or more. By means of these cellulose acylates, a solution having desirable solubility can be prepared. Particularly, a superior solution can be prepared in a non-chlorinate-based organic solvent. Moreover, a solution having low viscosity and a superior filtration property can be prepared.

The acyl group of the present invention having 3 to 22 carbon atoms may be an aliphatic group or an allyl group. No specific limitations are not imposed on the kind of acyl group. For instance, the acyl group includes an alkylcarbonyl ester, alkenyl carbonyl ester, aromatic carbonyl ester, and aromatic alkylcarbonyl ester of cellulose. These esters may additionally have a substituted group. Preferred acyl groups include propionyl, butanoyl, keptanoyl, hexanoyl, octanoyl, decanoyl, dodecanoyl, tridecanoyl, tetradecanoil, hexadecanoyl, octadecanoyl, iso-butanoyl, t-butanoyl, cyclohexane carbonyl, oleoyl, benzoyl, naphthyl carbonyl, a cinnamoyl group, or the like. Of these, propionyl, butanoyl, dodecanoyl, octadecanoyl, t-butanoyl, oleoyl, benzoyl, naphthyl carbonyl, and cinnamoyl are preferable. Propionyl and butanoyl are particularly preferable.

### (Method for Synthesizing Cellulose Acylate)

The basic principle of a method for synthesizing a cellulose acylate is described on pp. 180 to 190 in Wood Chemistry, Mikita et al. (Kyoritsu Publication Ltd., 1968). A typical synthesis method is a liquid-phase acetification method with carboxylic anhydride-acetate-sulfuric acid catalyst. Specifically, cellulose raw materials, such as raw cotton linters and wood pulp, are preprocessed by an appropriate amount of acetate and then charged into a cooled carboxylate mixed fluid to thus esterify the mixed fluid, thereby synthesizing perfect cellulose acylate (a total of acylation degrees achieved at the second position, the third position, and the sixth position is about 3.00). The carboxylate mixed fluid generally contains acetate serving as a solvent, an anhydrous carboxylic acid serving as an esterification agent, and a sulfate serving as a catalyst. The anhydrous carboxylic acid is usually used in an amount greater than a stoichiometric amount of cellulose reacting with the anhydrous carboxylic acid and a water content present in a system. After completion of acylation reaction, a solution of a neutralizer (e.g., a carbonate, acetate, or oxide of calcium, magnesium, iron, aluminum, or zinc) is added in order to neutralize a portion of hydrolysis of the excessive anhydrous carboxylic acid or a portion of an esterification catalyst present in the system. The obtained perfect cellulose acylate is maintained at 50 to 90° C. under the presence of a small amount of acetylation catalyst (generally a remaining sulfate), so that the cellulose acylate is saponified and ripened. Thus, the cellulose acylate is transformed to cellulose acylate having a desired degree of acylation and a desired degree of polymerization. At a point in time when desired cellulose acylate is obtained, the catalyst still remaining in the system is completely neutralized through use of the above-described neutralizer, or a solution of cellulose acylate is charged into water or a diluted sulfuric acid (or water or diluted sulfuric acid is charged into the solution of cellulose acylate) without neutralizing the catalyst, to thus separate cellulose acylate. The thus-separated cellulose acylate is subjected to washing and stabilization, to thus produce cellulose acylate.

In the cellulose acylate of the present invention, a polymer component forming a film is made substantially from the above-described preferable cellulose acylate. Here, the term “substantially” signifies a polymer content of 55 weight percent or more (preferably 70 weight percent or more, more preferably 80 weight percent or more).

Use of cellulose acylate particle as raw materials of the film s is preferable. Preferably, 90 weight percent or more of particles used assume a particle size of 0.5 to 5 mm. Preferably, 50 weight percent or more of particles used assume a particle size of 1 to 4 mm. Cellulose acylate particles preferably assume a shape bearing as close a resemblance as possible to a sphere.

In connection with a polymerization degree of cellulose acylate preferably used in the present invention, a viscosity-average polymerization degree preferably falls within a range of 200 to 700, more preferably within a range of 250 to 550, much more preferably within a range of 250 to 400, and particularly preferably within a range of 250 to 350. The average polymerization degree can be measured by means of a limiting viscosity method of Uda et al. (pp. 105 to 120 of Kazuo UDA and Hideo SAITO, Review of the Society of Fiber Science and Technology, Volume 18 of 1^{st} issue, 1962). The method is also described in detail in JP-A-9-95538.

An average molecular weight (i.e., the polymerization degree) becomes high as a result of removal of low molecular weight components. However, the cellulose acylate becomes lower in viscosity than ordinary cellulose acylate and hence is useful. Cellulose acylate having few low molecular weight components can be produced by removal of low molecular weight components from the cellulose acylate synthesized by an ordinary method. Removal of low molecular weight components can be effected by washing cellulose acylate with an appropriate organic solvent. When cellulose acylate having few low molecular weight components is manufactured, the amount of sulfur catalyst used in acetylation reaction is preferably set to 0.5 to 25 parts by weight with respect to 100 parts by weight of cellulose. As a result of the amount of sulfur catalyst being set so as to fall within the foregoing range, a cellulose acylate sheet which is also desirable in terms of molecular weight distribution (having, e.g., a uniform distribution of molecular weight) can be synthesized.

When the cellulose acylate is used for manufacturing a cellulose acylate film of the present invention, a moisture content of cellulose acylate is preferably 2 weight percent or less, more preferably 1 weight percent or less, and particularly preferably 0.7 weight percent or less. Generally, the cellulose acylate contains water and is known to have 2.5 to 5 weight percent of water. In the present invention, in order to achieve the water content of cellulose acylate, drying is required. No limitations are imposed on a method of drying, so long as a target water content is attained.

The raw material cotton and the synthesis method of the cellulose acylate of the present invention are described in detail on pp. 7 to 12 of Journal of Technical Disclosure published by Japan Institute of Innovation and Invention (Journal of Technical Disclosure Number 2001-1745, issued by Japan Institute of Innovation and Invention on Mar. 15, 2001).

### (Additives)

Various additives (e.g., a plasticizer, a ultraviolet inhibitor, an anti-degradation agent, a retardation (optical anisotropy) modifier, particulates, a parting agent, an ultraviolet absorber, an infrared-radiation absorber, or the like) can be added to the solution of the cellulose acylate of the present invention during the course of preparation processes. These additives may be solids or oily substances. For instance, addition of an additive includes mixing of an ultraviolet absorber at 20° C. or less and 20° C. or more, as described in, e.g., JP-A-2001-151901. Ethyl esters of citrate can be provided as examples of the parting agent. In addition, the IR absorbing dye is described in, e.g., JP-A-2001-194522. Although the additive may be added at any time during the course of preparation of a dope, a process for adding an additive and preparing the resultant material may be added to the final preparation step in the dope preparation process, and the additive may be added. Moreover, no limitations are imposed on the amount of additives of respective raw materials, so long as the functions of the additives are exhibited. In addition, it may also be the case that, when the acylate cellulose film is formed from multiple layers, the types and dosages of additives in respective layers become different. For instance, the amounts and types of additives are as described in, e.g., JP-A-2001-151902. This is a conventionally-known technique. Preferably, the glass transition point Tg of the acylate cellulose film is set to 70 to 135° C. and setting the elastic modulus to be measured by a tensile tester is set to 1500 to 5000 Mpa by means of selecting the types and amounts of additives to be added.

These types and amounts of additives are described in detail on pg. 16 and subsequent pages of Journal of Technical Disclosure published by Japan Institute of Innovation and Invention (Journal of Technical Disclosure Number 2001-1745, issued by Japan Institute of Innovation and Invention on Mar. 15, 2001), and raw materials exemplified in the journal are preferably used.

### (Retardation-developing Agent)

In order to exhibit a retardation value, a discotic compound or a rod-like compound can be preferably used as a retardation-developing agent. Examples of the discotic compound or the rod-like compound include a compound having at least two aromatic rings. With respect to 100 parts by weight of polymer, the retardation-developing agent is used preferably in the range of 0.05 to 20 parts by weight, more preferably in the range of 0.1 to 10 parts by weight, further preferably in the range of 0.2 to 5 parts by weight, and most preferably in the range of 0.5 to 2 parts by weight. Two types or more retardation-developing agents may be used in combination.

The retardation-developing agent preferably exhibits maximum absorption within the wavelength range of 250 to 400 nm and preferably exhibits no substantial absorption in the visible range.

In addition to including the aromatic hydrocarbon ring, the term “aromatic ring” used herein encompasses an aromatic hetero ring.

The aromatic hydrocarbon ring is particularly preferably a six-member ring (i.e., a benzene ring).

The aromatic hetero ring is usually an unsaturated hetero ring. The aromatic hetero ring is preferably a five-member ring, a six-member ring, or a seven-member ring; more preferably a five-member ring or a six-member ring. The aromatic hetero ring usually has the greatest number of double bonds. A nitrogen atom, an oxygen atom, and a sulfur atom are desirable as the hetero atom, and the nitrogen atom is especially desirable. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyran ring, a pyridine ring, a pyridazine ring, a pyrimidine ring, a pyrazine ring, and a 1,3,5-triazine ring.

A benzene ring, a furan ring, a thiophene ring, a pyrrole ring, an oxazole ring, a thiazole ring, an imidazole ring, a triazole ring, a pyridine ring, a pyrimidine ring, a pyrazine ring, or a 1,3,5-triazine ring is preferably used as the aromatic ring. Specifically, the compounds described in, e.g., JP-A-2001-166144, are preferably used.

The number of aromatic rings belonging to the retardation-developing agent is preferably 2 to 20, more preferably 2 to 12, much more preferably 2 to 8, and most preferably 2 to 6.

A bonding relationship between two aromatic rings can be classified into: a case (a) where a condensed ring is formed; a case (b) where the two aromatic rings are directly connected together by means of a single bond; and a case (c) where the two aromatic rings are connected together by way of a coupling group (a spiro bond cannot be formed because of the aromatic ring). Any one of the bonding relationships classified as (a) to (c) may be adopted.

Preferred examples of the condensed ring (a condensed ring of two or more aromatic rings) of (a) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, a benzoxazole ring, a benzothiazole ring, an benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring, and a thianthrene ring. The naphthalene ring, the azulene ring, the indole ring, the benzoxazole ring, the benzothiazole ring, the benzimidazole ring, the benzotriazole ring, and the quinoline ring are desirable.

The single bond of (b) is preferably a bond between carbon atoms of two aromatic rings. An aliphatic ring or a non-aromatic heterocycle may be formed between two aromatic rings by means of bonding two aromatic rings by means of two or more single bonds.

The coupling group of (c) is preferably bonded to carbon atoms of two aromatic rings, as well. The coupling group is preferably an alkylene group, an alkenylene group, an alkynylene group, —CO—, —O—, —NH—, —S—, or a mixture thereof. Examples of the coupling group consisting of the combinations are provided below. Positions of the exemplified coupling groups may be switched from one side to the other side.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the coupling group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, a aliphatic acyl group, a aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, a substituted aliphatic amino group, a substituted aliphatic carbamoyl group, a substituted aliphatic sulfamoyl group, a substituted aliphatic ureide radical, and a non-aromatic heterocycle group.

The number of carbon atoms of the alkyl group desirably falls within the range of 1 to 8. A chain alkyl group is more desirable than a cyclic alkyl group, and a straight-chain alkyl group is especially desirable. The alkyl group may further have a substituent (e.g., hydroxy, carboxy, an alkoxy group, and a substituted alkyl amino group). Examples of the alkyl group (including the substituted alkyl group) include methyl, ethyl, n-butyl, n-hexyl, 2-hydroxyethyl, 4-carboxybutyl, 2-methoxyethyl, and 2-diethylaminoethyl.

The number of carbon atoms of the alkenyl group desirably falls within the range of 2 to 8. A chain alkenyl group is more desirable than a cyclic alkenyl group, and a straight-chain alkenyl group is especially desirable. The alkenyl group may further have a substituent. Examples of the alkenyl group include vinyl, aryl, and 1-hexenyl.

The number of carbon atoms of the alkynyl group desirably falls within the range of 2 to 8. A chain alkynyl group is more desirable than a cyclic alkynyl group, and a straight-chain alkynyl group is especially desirable. The alkynyl group may further have a substituent. Examples of the alkynyl group include ethynyl, 1-butynyl, and 1-hyxynyl.

The number of carbon atoms of the aliphatic acyl group desirably falls within the range of 1 to 10. Examples of the acyl group include acetyl, propanoyl, and butanoyl.

The number of carbon atoms of the aliphatic acyloxy group desirably falls within the range of 1 to 10. Examples of the acyloxy group include acetoxy.

The number of carbon atoms of the alkoxy group desirably falls within the range of 1 to 8. The alkoxy group may further have a substituent (e.g., an alkoxy radical). Examples of the alkoxy group (including the substituted alkoxy group) include methoxyl ethoxy, butoxy, and methoxyethoxy.

The number of carbon atoms of the alkoxycarbonyl group desirably falls within the range of 2 to 10. Examples of the alkoxycarbonyl group include methoxycarbonyl and ethoxycarbonyl.

The number of carbon atoms of the alkoxycarbonyl amino group desirably falls within the range of 2 to 10. Examples of the alkoxycarbonyl amino group include methoxycarbonyl amino and ethoxycarbonyl amino.

The number of carbon atoms of the alkylthio group desirably falls within the range of 1 to 12. Examples of the alkynylthio group include methylthio, ethynylthio, and octylthio.

The number of carbon atoms of the alkynylsulfonyl group desirably falls within the range of 1 to 8. Examples of the alkylsulfonyl group include methanesulphonyl and ethanesulfonyl.

The number of carbon atoms of the aliphatic amid group desirably falls within the range of 1 to 10. Examples of the aliphatic amid group include acetamide.

The number of carbon atoms of the aliphatic sulfonamide group desirably falls within the range of 1 to 8. Examples of the aliphatic sulfonamide group include methanesulphonamide, butane sulphonamide, and n-octanesulphonamide.

The number of carbon atoms of the substituted aliphatic amino group desirably falls within the range of 1 to 10. Examples of the substituted aliphatic amino group include dimethylamino and 2-carboxyethyl amino.

The number of carbon atoms of the substituted aliphatic carbamoyl group desirably falls within the range of 2 to 10. Examples of the substituted aliphatic carbamoyl group include methylcarbamoyl and diethylcarbamoyl.

The number of carbon atoms of the substituted aliphatic sulfamoyl group desirably falls within the range of 1 to 8. Examples of the substituted aliphatic sulfamoyl group include methylsulfamoyl and diethylsulfamoyl.

The number of carbon atoms of the substituted aliphatic ureido group desirably falls within the range of 2 to 10. Examples of the aliphatic ureido group include methylureido.

Examples of the non-aromatic heterocycle group include piperidino and morpholino.

The molecular weight of the retardation-developing agent is desirably 300 to 800.

In addition to the compound using the 1,3,5-triazine ring, a rod-like compound having a linear molecular structure can also be preferably used. The linear molecular structure means that the molecular structure of the rod-like compound is linear in connection with a structure which is most thermodynamically stable. The structure that is most thermodynamically stable can be determined by analysis of a crystal structure or computation of a molecular orbit. For instance, a molecular orbit is computed through use of molecular orbital computation software (e.g., WinMOPAC2000 manufactured by Fujitsu Ltd.), and the structure of a molecule where heat generated by a compound is minimized can be determined. The molecular structure being linear signifies that an angle made between the principal chains of the molecular structure is 140 degrees or more in connection with the structure which is computed in the foregoing manner and most stable thermodynamically.

Compounds expressed by formula (1) provided below are preferable as the rod-like compound having at least two aromatic rings:

Ar1-L1-Ar2. formula (1)

In the above-mentioned formula (1), Ar1 and Ar2 each independently designate a aromatic group.

In the present invention, the aryl group and the substituted aryl group are more desirable than the aromatic hetero ring group and the substitution aromatic hetero ring group. The hetero ring of the aromatic hetero ring is usually unsaturated. The aromatic hetero ring is preferably a five-member ring, a six-member ring, or a seven-member ring; more preferably a five-member ring or a six-member ring. The aromatic hetero ring usually has the greatest number of double bonds. A nitrogen atom, an oxygen atom, and a sulfur atom are desirable as the hetero atom, and the nitrogen atom or the sulfur atom is more desirable. A benzene ring, a furan ring, a thiophene ring, a pyrrole ring, an oxazole ring, a thiazole ring, an imidazole ring, a triazole ring, a pyridine ring, and a pyridazine ring are preferable as the aromatic ring of the aromatic group. The benzene ring is especially desirable.

Example substituents of the substituted aryl group and those of the substituted aromatic hetero ring include a halogen atom (F, Cl, Br, I), a hydroxyl group, a carboxyl group, a cyano group, an amino group, an alkylamino group (e.g., methylamino, ethylamino, butylamino, and dimethylamino), a nitro group, a sulfo group, a carbamoyl group, an alkylcarbamoyl group (e.g., N-methylcarbamoyl, N-ethylcarbamoyl, and N, N-dimethylcarbamoyl), a sulfamoyl group, an alkylsulfamoyl group (e.g., N-methyl sulfamoyl, N-ethyl sulfamoyl, N,N-dimethyl sulfamoyl), ureide, an alkyl ureido group (e.g., N-methyl ureide, N,N-dimethyl ureide, and N,N,N′-trimethyl ureide), an alkyl group (e.g., methyl, ethyl, propyl, butyl, pentyl, heptyl, octyl, isopropyl, s-butyl, t-amyl, cyclohexyl, and cyclopentyl), an alkenyl group (e.g., vinyl, aryl, and hexenyl), an alkynyl group (e.g., ethynyl, and butynyl), an acyl group (e.g., formyl, acetyl, butyryl, hexanoyl, and lauryl), an acyloxy group (e.g., acetoxy, butyryloxy, hexanoyloxy, and lauryloxy), an alkoxy group (e.g., methoxy, ethoxy, propoxy, butoxy, pentyloxy, heptyloxy, and octyloxy), an aryloxy group (e.g., phenoxy), an alkoxycarbonyl group (e.g., methoxycarbonyl, ethoxycarbonyl, propoxycarbonyl, butoxycarbonyl, pentyloxycarbonyl, and heptyloxycarbonyl), an aryloxy carbonyl group (e.g., phenoxy carbonyl), an alkoxycarbonylamino group (e.g., butoxycarbonyl amino, and hexyloxycarbonylamino), an alkylthio group (e.g., methylthio, ethylthio, propylthio, butylthio, pentylthio, heptylthio, and octylthio), an arylthio group (e.g., phenylthio), an alkylsulfonyl group (e.g., methylsulfonyl, ethylsulfonyl, propylsulfonyl, butylsulfonyl, pentylsulfonyl, heptylsulfonyl, and octylsulfonyl), an amide group (e.g., acetamide, a butyramide group, hexyl amid, and lauryl amid), and a non-aromatic heterocycle group (e.g., morphoryl, and pyrazinyl).

The halogen atom, the cyano group, the carboxyl group, the hydroxyl group, the amino group, and the substituted alkyl amino group, the acyl group, the acyloxy group, the amide group, the alkoxycarbonyl group, the alkoxy group, the alkylthio group, and the alkyl group are preferable as the substituent of the substituted aryl group and that of the substitution aromatic hetero ring group.

The alkyl portion of the alkylamino group, the alkoxycarbonyl group, the alkoxy group and the alkylthio group, and the alkyl group may additionally have a substituent. Examples of the alkyl portion and those of the substituent of the alkyl group include a halogen atom, a hydroxyl group, a carboxyl group, a cyano group, an amino group, an alkylamino group, a nitro group, a sulfo group, a carbamoyl group, an alkylcarbamoyl group, sulfamoyl, an alkyl sulfamoyl group, ureide, an alkyl ureido group, an alkenyl group, an alkynyl group, an acyl group, an acyloxy group, an alkoxy group, an aryloxy group, an alkoxycarbonyl group, an aryloxycarbonyl group, an alkoxycarbonylamino radical, an alkylthio group, an arylthio group, an alkylsulfonyl group, an amide group, and a non-aromatic heterocycle group. The halogen atom, hydroxyl, amino, the alkylamino group, acyl, the acyloxy group, the acylimino group, the alkoxycarbonyl group, and the alkoxy group are preferable as a substituent of the alkyl portion and that of the alkyl group.

In formula (1), L1 is a bivalent group selected from the groups consisting of an alkylene group, an alkenylene group, an alkynylene group, —O—, —CO—, or a mixture thereof.

The alkylene group may have a ring structure. Cyclohexylene is preferable as the ring alkylene group, and 1,4-cyclohexylene is particularly preferred. A straight-chain alkylene group is more preferable as a chain alkylene group than is an alkylene group having a branch.

The number of carbon atoms of the alkylene group desirably falls within the range of 1 to 20; more desirably within the range of 1 to 15; much more desirably within the range of 1 to 10; further more desirably within the range of 1 to 8; and most desirably within the range of 1 to 6.

The alkenylene group and the alkynylene group preferably have a chain structure rather than a ring structure and more preferably have a straight chain structure rather than a chain structure having a branch.

The number of carbon atoms of the alkenylene group and that of the alkynylene group preferably fall within the range of 2 to 10, more preferably within the range of 2 to 8, much more preferably within the range of 2 to 6, further more preferably within the range of 2 to 4, and is most preferably 2 (vinylene or ethynylene).

The number of carbon atoms of the arylene group preferably falls within the range of 6 to 20, more preferably within the range of 6 to 16, and further more preferably within the range of 6 to 12.

In the molecular structure expressed by formula (1), an angle defined by Ar1 and Ar2 with L1 sandwiched therebetween is preferably 140 degrees or more.

A compound expressed by formula (2) provided below is more preferable as the rod-like compound:

Ar1-L2-X-L3-Ar2. formula (2)

In formula (2), Ar1 and Ar2 each independently designate a aromatic group. The definition and examples of the aromatic group are the same as those provided for Ar1 and Ar2 of formula (1).

In formula (2), L2 and L3 are independently bivalent groups selected from the groups consisting of an alkylene group, —O—, —CO—, or a mixture thereof.

The alkylene group preferably has a chain structure rather than a ring structure and more preferably has the straight chain structure rather than a chain structure having a branch.

The number of carbon atoms of the alkynylene group preferably falls within the range of 1 to 10, more preferably within the range of 1 to 8, much more preferably within the range of 1 to 6, further more preferably within the range of 1 to 4, and is most preferably 1 or 2 (methylene or ethylene).

L2 and L3 are particularly preferably —O—CO— or —CO—O—.

In formula (2), X designates 1,4-cyclohexylene, vinylene, or ethynylene.

Specific examples of the compound expressed by formula (1) are provided below.

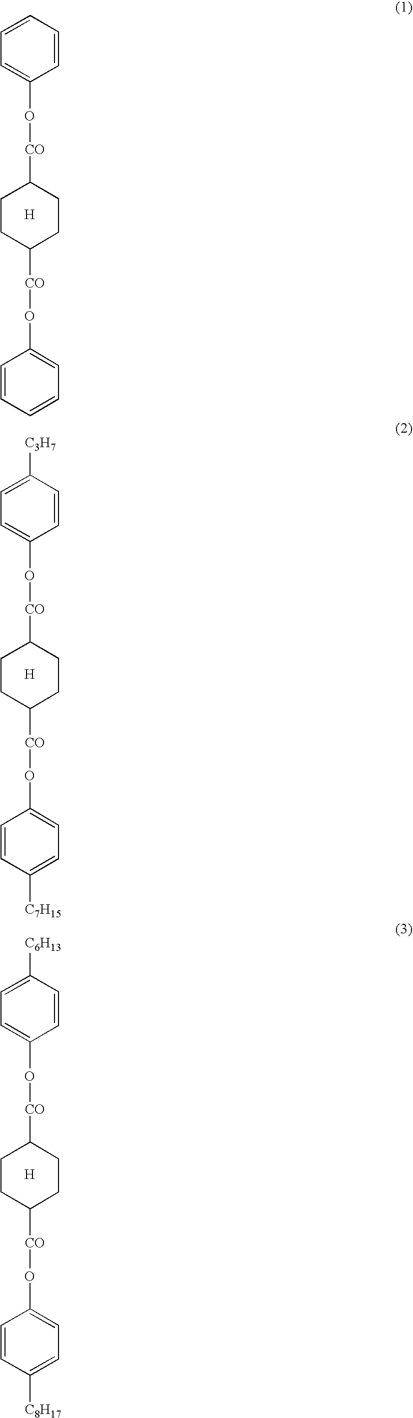

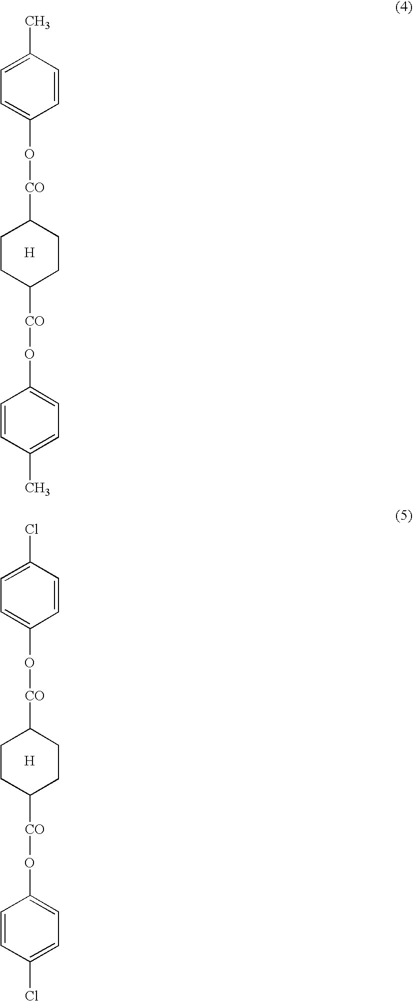

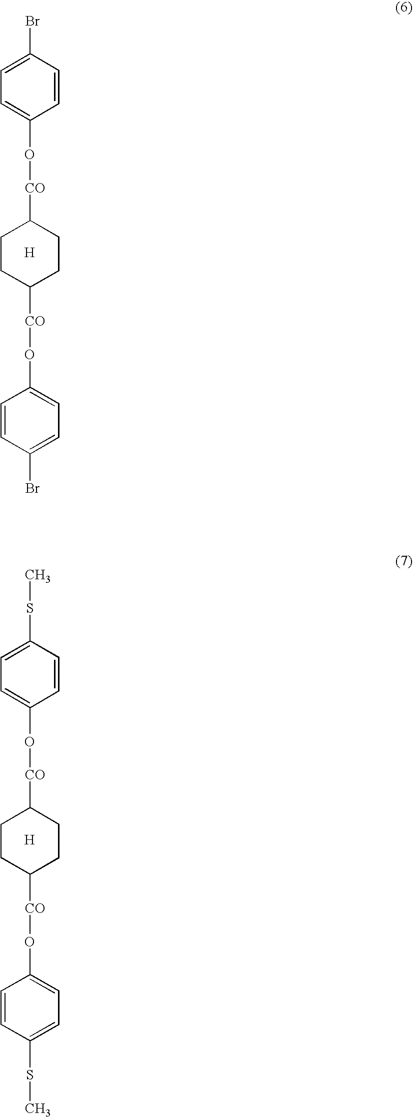

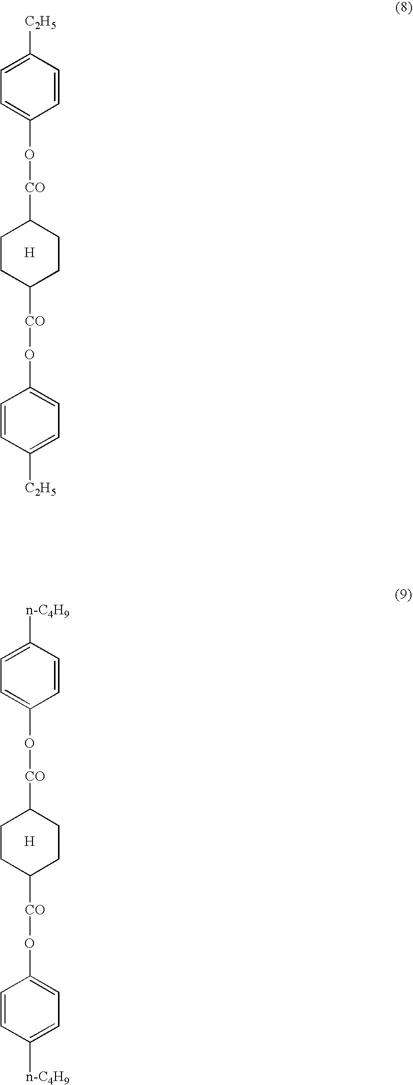

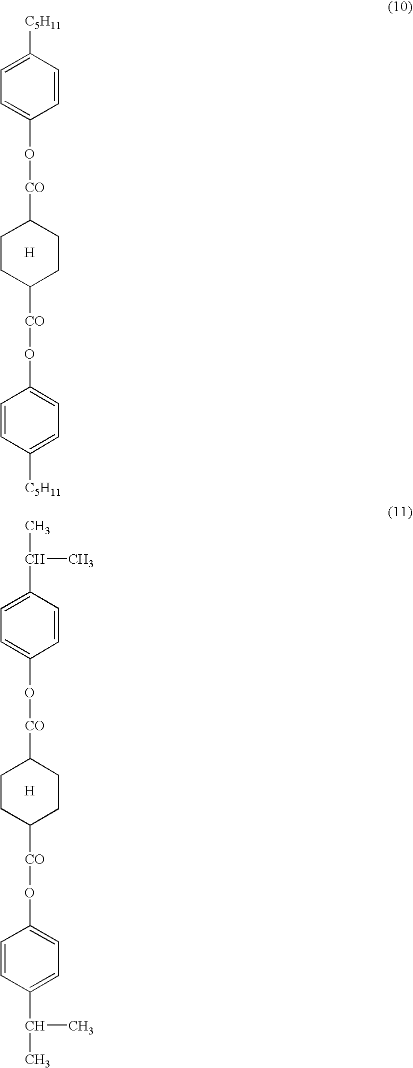

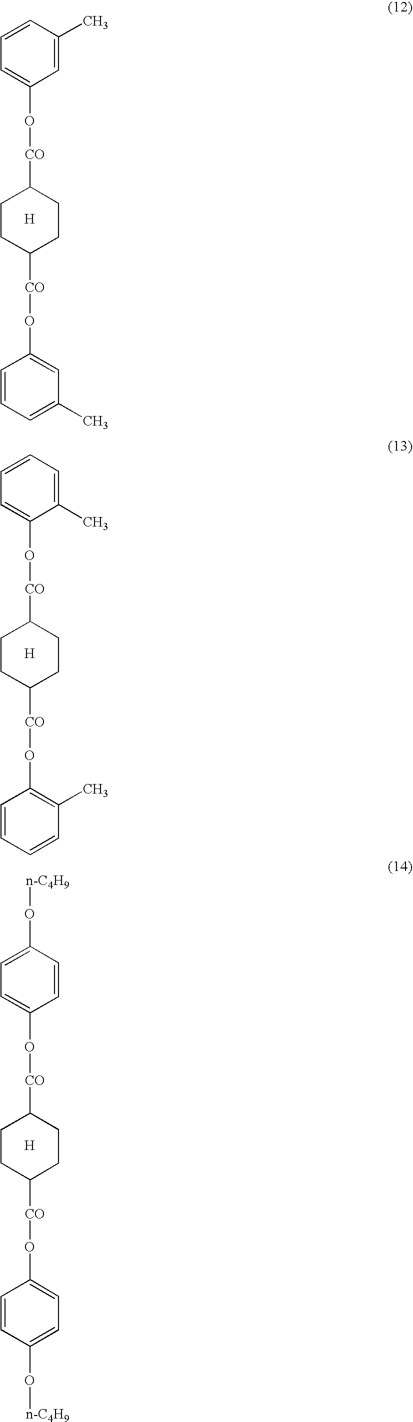

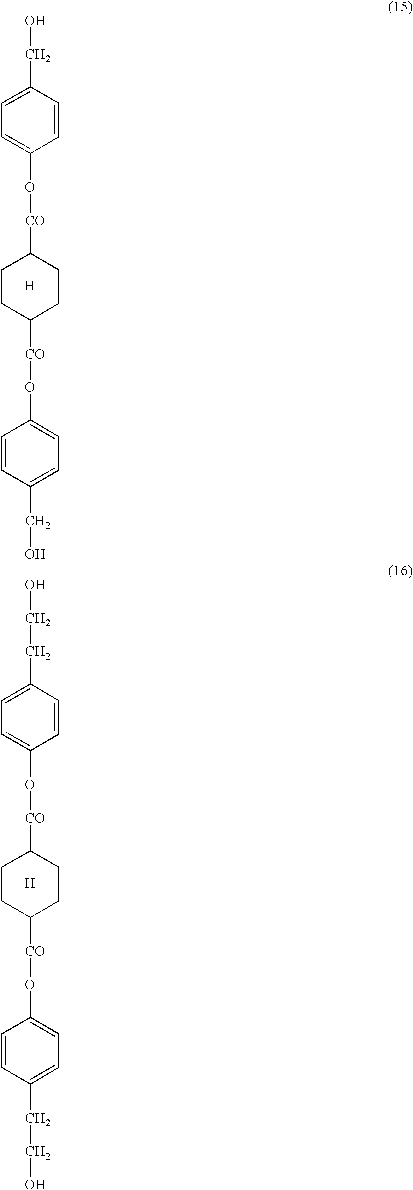

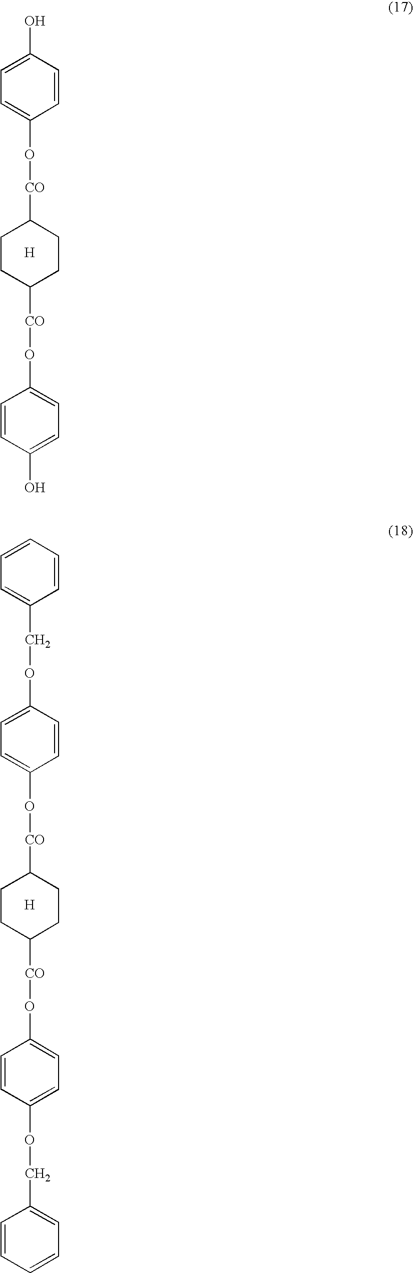

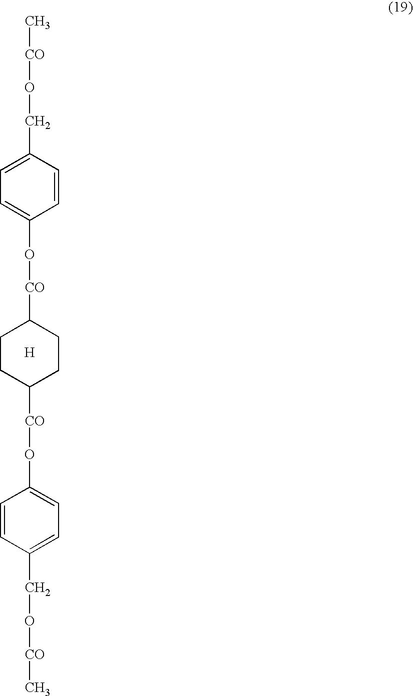

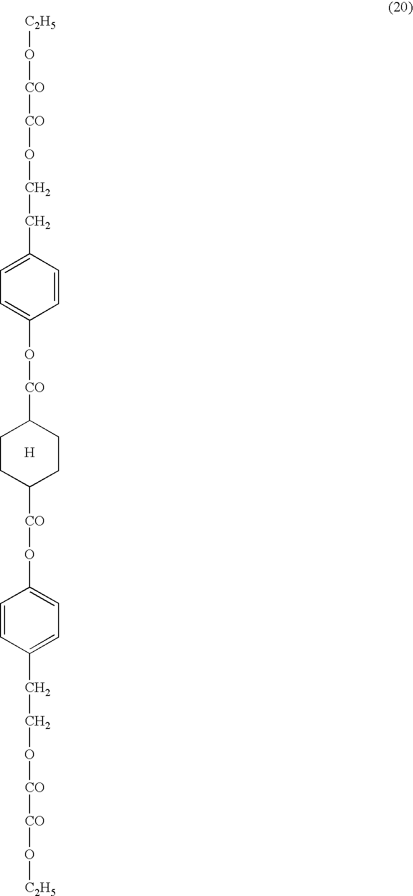

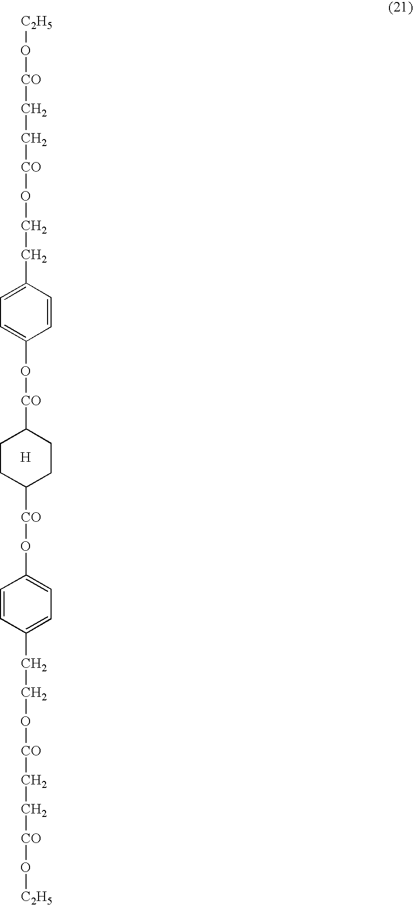

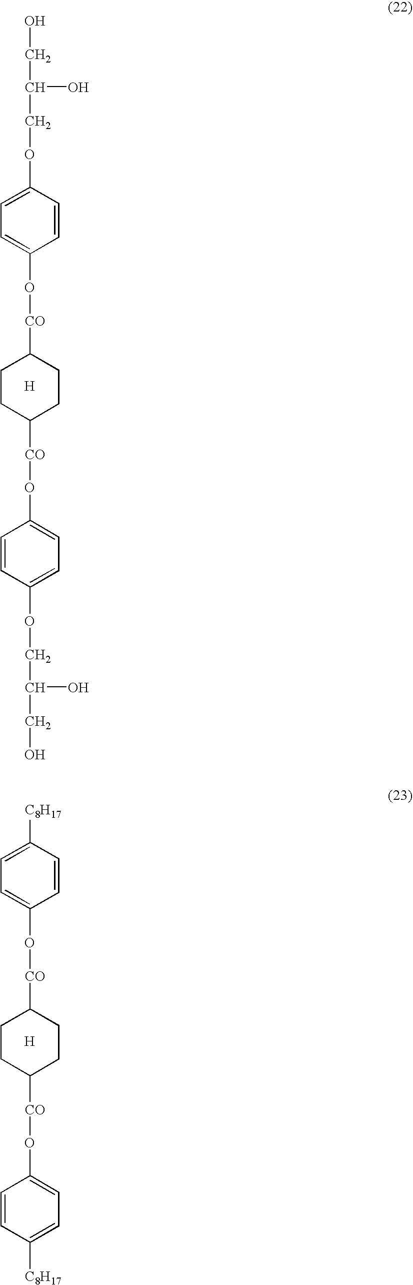

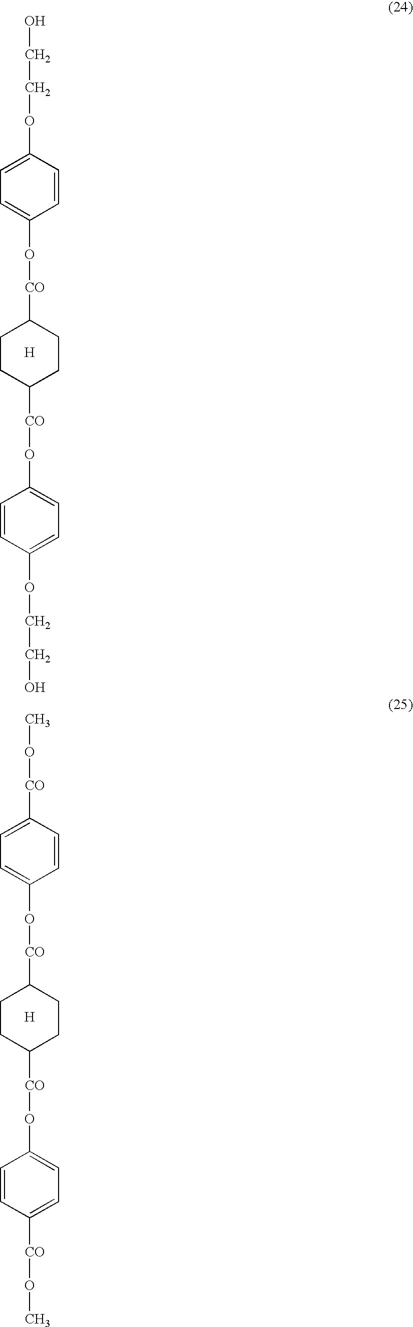

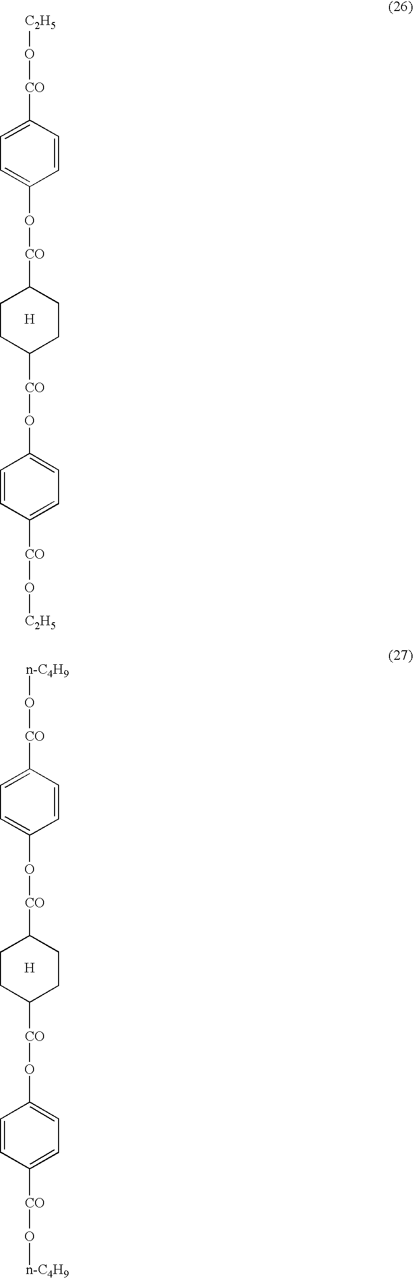

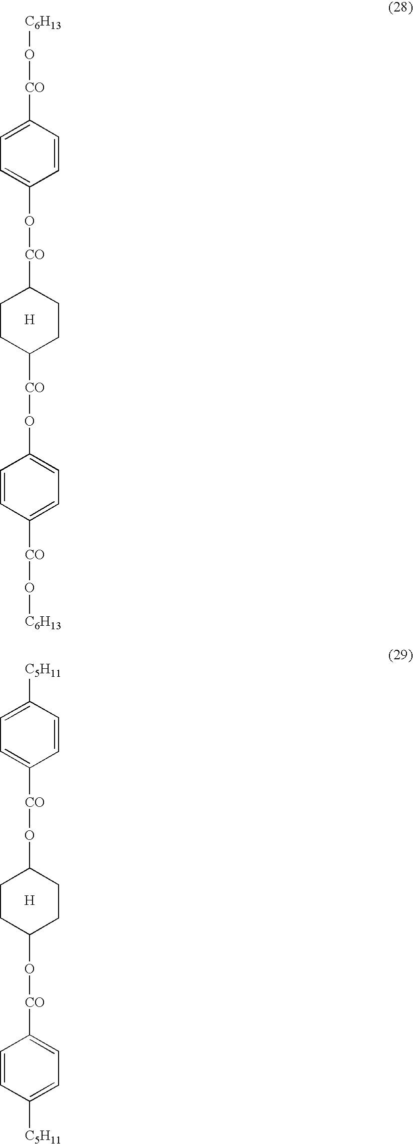

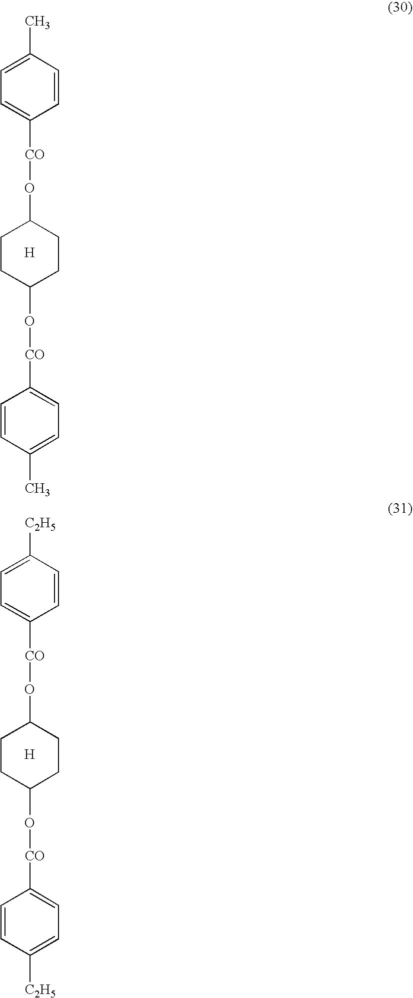

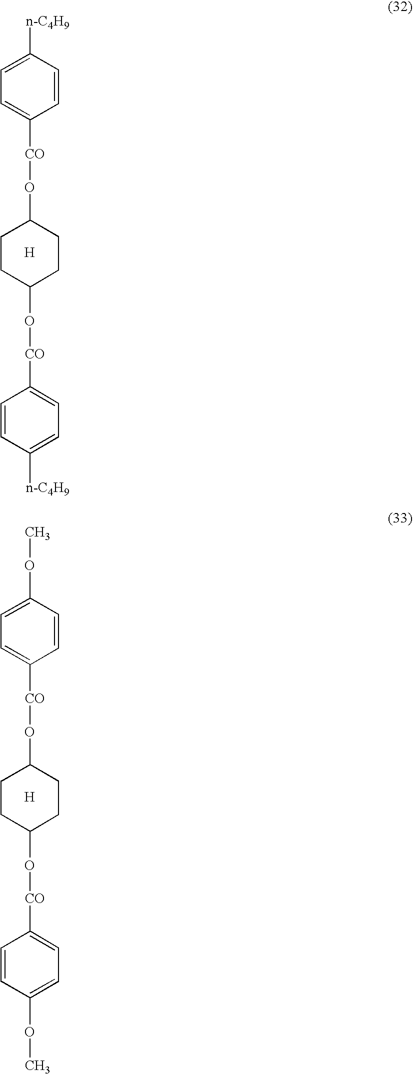

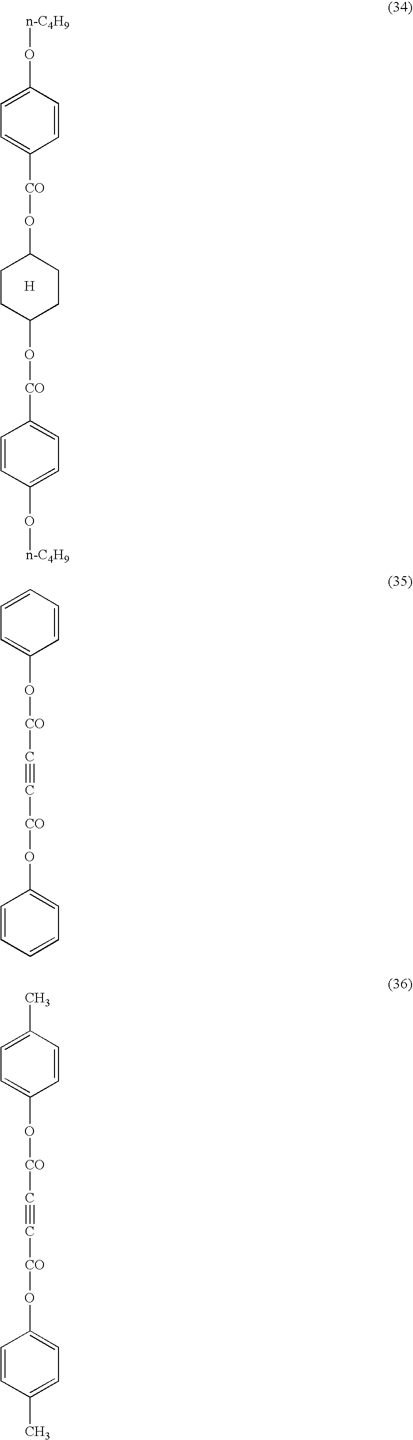

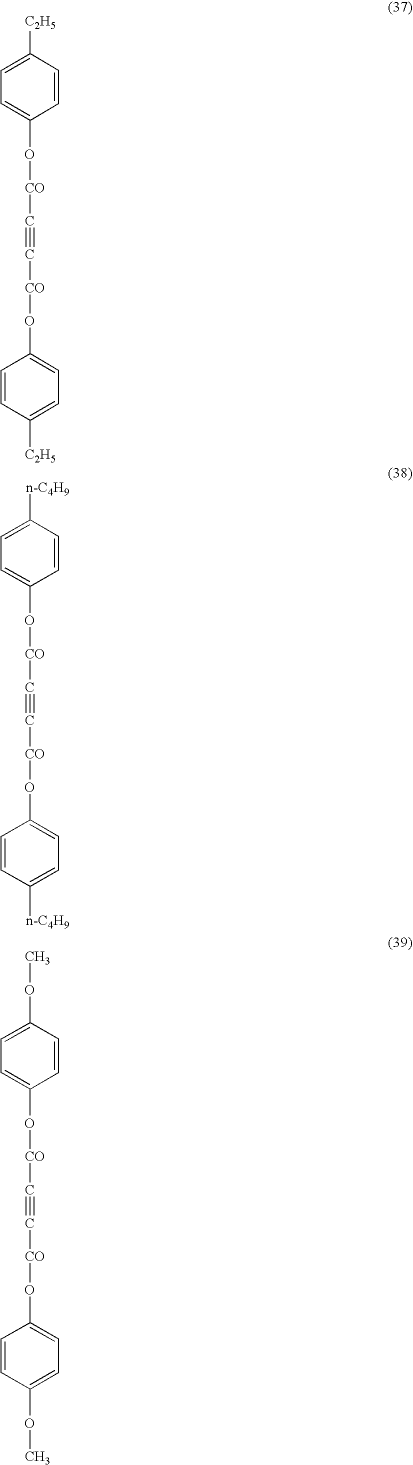

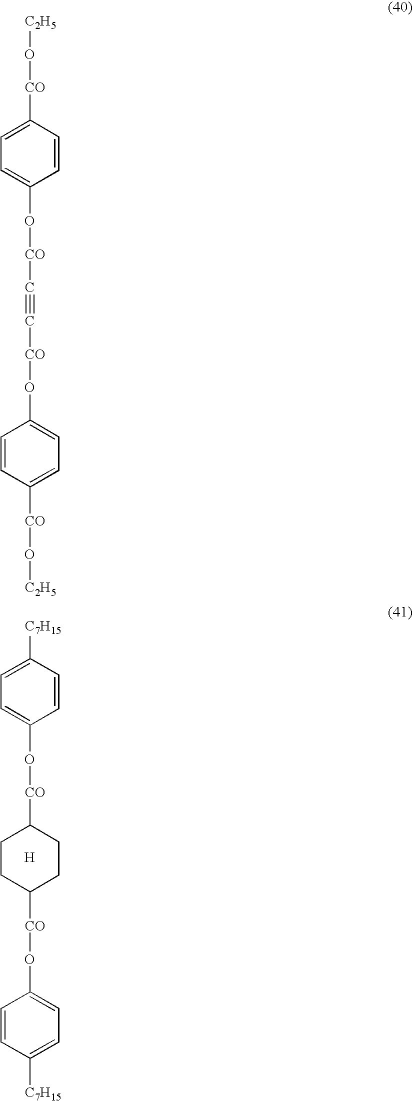

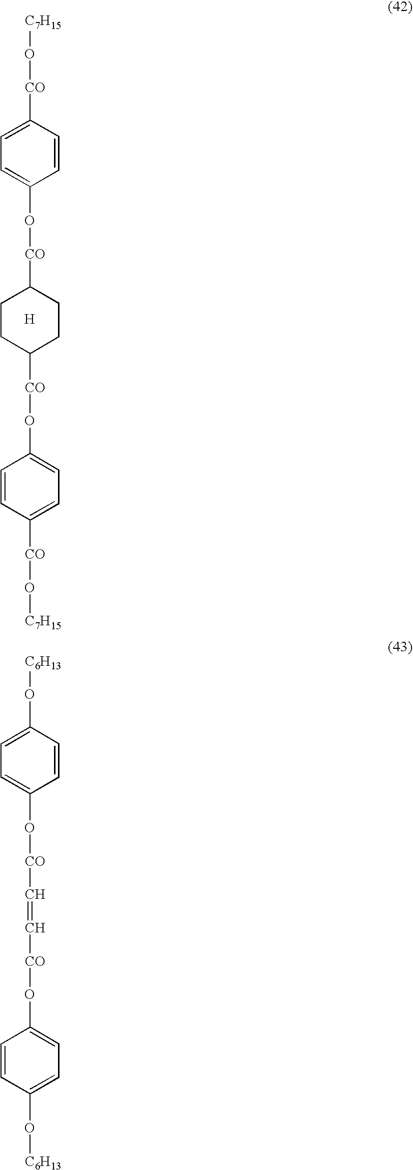

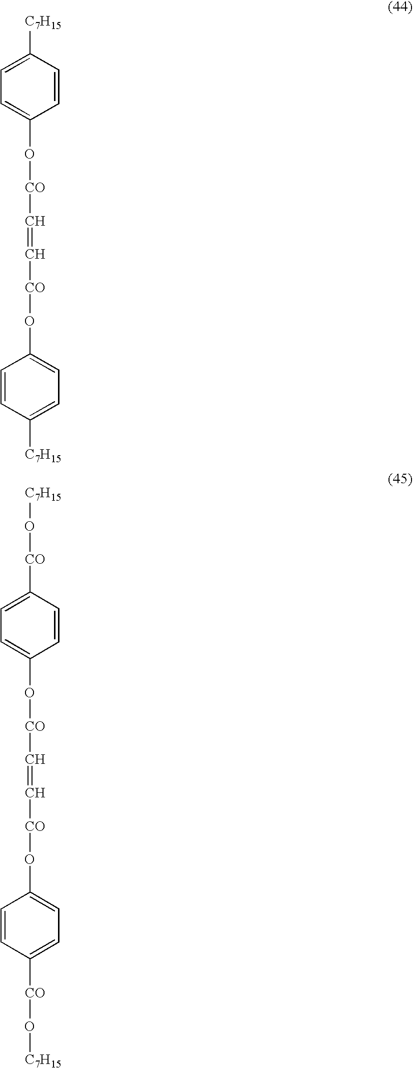

Specific examples (1) to (34), (41), and (42) each have two asymmetric carbon atoms, in the first and fourth positions of a cyclohexane ring. However, specific examples (1), (4) to (34), (41), and (42) each have a symmetric molecular structure of meso form and, hence, exhibit no optical isomerism (optical activity). Only a geometrical isomer (of trans form and cis form) exists in the structure. Trans form (1-trans) and cis form (1-cis) of Specific Example (1) are provided below.

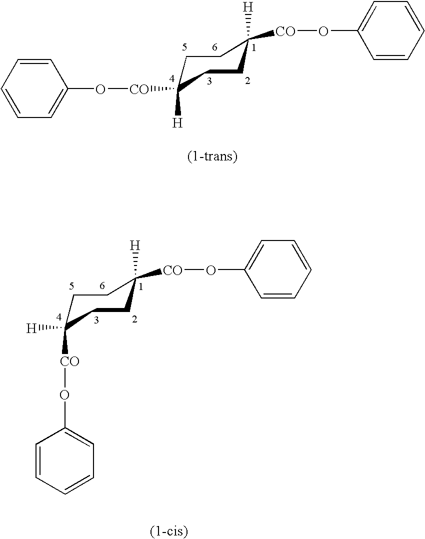

As mentioned previously, the rod-like compound preferably has a linear molecular structure. For this reason, the trans form is more preferable than the cis form.

Specific examples (2) and (3) have optical isomers (a total of four types of isomers) in addition to geometrical isomers. In relation to the geometrical isomers, a geometrical isomer of trans form is similarly more preferable than a geometrical isomer of cis form. The optical isomers have neither particular superiority nor particular inferiority. The geometrical isomers may be of any of D, L, or a racemic compound.

In relation to specific examples (43) to (45), a center vinylene bond is classified into a vinylene bond of trans form and a vinylene bond of cis form. For reasons similar to those mentioned previously, the vinylene bond of trans form is more preferable than the vinylene bond of cis form.

Additionally, other preferable compounds are provided below.

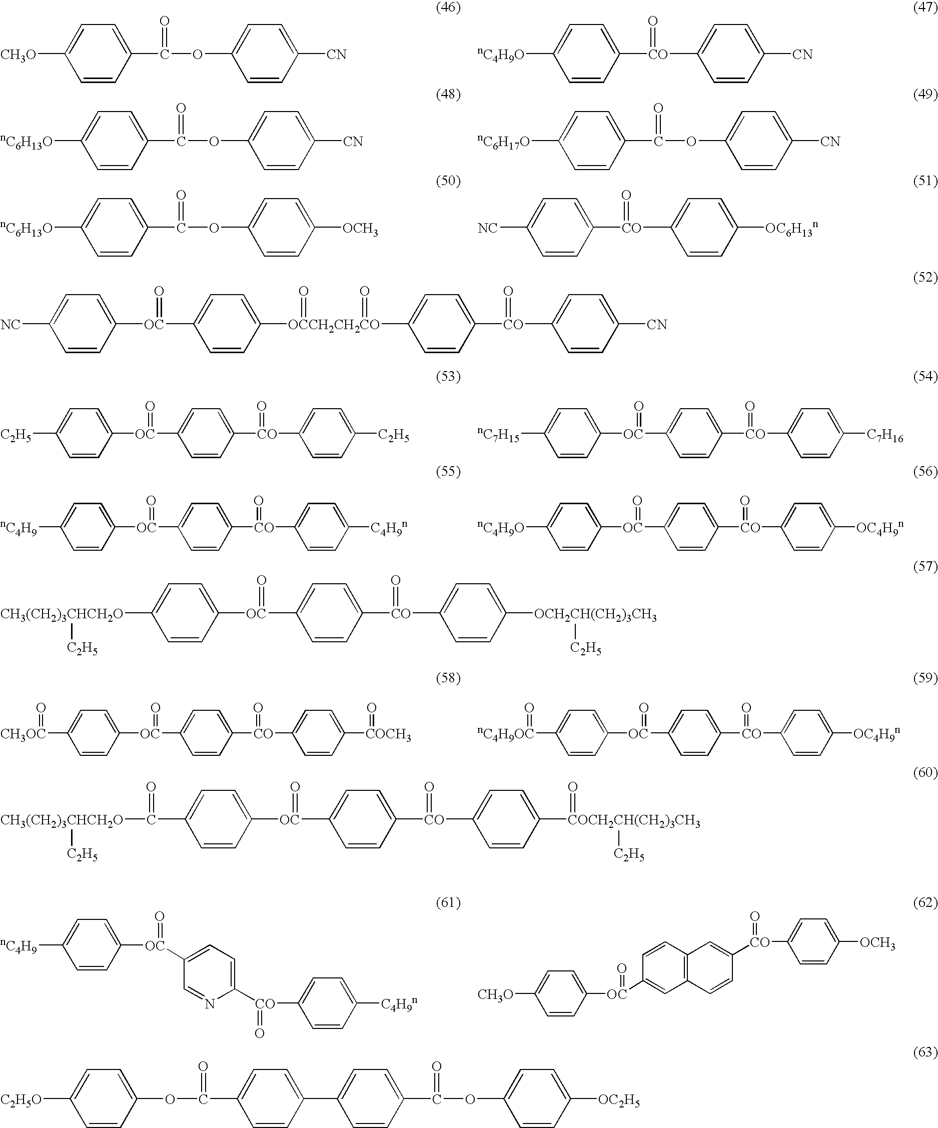

Two or more types of rod-like compounds may be used in combination, wherein a wavelength (λmax)—at which a solution has a maximum absorbance in UV spectrum—is shorter than 250 nm.

The rod-like compound can be synthesized by reference to methods described in documents. The documents include pg. 229 of Mol. Cryst. Liq. Cryst., Vol. 53 (1979); pg. 145 of the same Vol. 89 (1982); pg. 111 of the same Vol. 145 (1987); pg. 43 of the same, Vol. 170 (1989); pg. 1349 of J. Am. Chem. Soc., Vol. 113 (1991); pg. 5346 of the same, Vol. 118 (1996); pg. 1582 of the same Vol. 92 (1970); and pg. 420 of J. Org. Chem., Vol. 40 of the 16^{th} issue (1992).

The content of the retardation-developing agent is preferably 0.1 to 30 weight percent of the quantity of the polymer, more preferably 0.5 to 20 weight percent.

(Mat Agent Particles)

Addition of fine particles to the acylate cellulose film of the present invention as a mat agent is desirable. Fine particles used herein include a silicon dioxide, a titanium dioxide, an aluminum oxide, a zirconia, a calcium carbonate, a talc, a clay, a baked kaolin, a baked calcium silicate, a hydrated calcium silicate, an aluminium silicate, a magnesium silicate, and a calcium phosphate. In view of a decrease in turbidity, fine particles containing a silicon are preferable, and fine particles containing the silicon dioxide are particularly preferable. Preferred fine particles of the silicon dioxide have an average primary particle size of 20 nm or less or an apparent specific gravity of 70 g/liter or more. The silicon dioxide whose primary particles have an average particle size of 5 to 16 nm is more preferable, because the particles can lessen the haze of a film. Particles having an apparent specific gravity of 90 to 200 g/liter or more are desirable, and particles having an apparent specific gravity of 100 to 200 g/liter or more are more preferable. As the apparent specific gravity becomes greater, a higher-density dispersion liquid can be prepared, whereby the haze and aggregates are improved. For this reason, the fine particles having a larger apparent specific gravity are desirable.

These fine particles form secondary particles usually having an average particle size of 0.1 to 3.0 μm. These fine particles exist as an aggregation of the primary particles, thereby forming irregularities of 0.1 to 3.0 μm in the surface of the film. The average particle size of the secondary particles desirably falls within the range of 0.2 to 1.5 μm, more desirably within the range of 0.4 to 1.2 μm, and most preferably within the range of 0.6 to 1.1 μm. The sizes of the primary and secondary particles were determined by observing particles in a film with a scanning electron microscope and measuring the diameter of a circle circumscribing each particle. Two hundred particles were observed while locations were changed, and an average of the thus-observed particle sizes was taken as an average particle size.

Commercial products; e.g., Aerosil (Registered Trademark) R972, R972V, R974, R812, 200, 200V, 300, R202, OX50, TT600 (manufactured by Japan Aerosil Ltd.,), can be used as fine particles of silicon dioxide. For instance, products commercially available under the trade name of Aerosil (Registered Trademark) R976 and R811 (manufactured by Japan Aerosil Ltd.,) can be used as fine particles of the zirconia.

Among these commercial products, Aerosil 200V and Aerosil R972V are particles of the silicon dioxide whose primary particles have an average particle size of 20 nm or less and which have an apparent specific gravity of 70 g/liter or more. These particles yield a great effect of lowering fiction coefficients while maintaining the turbidity of the optical film low, and hence are particularly desirable.

Several techniques can be conceivably employed at the time of preparation of a dispersed solution of fine particles in order to produce a cellulose acylate film having secondary particles of small average particle size. For instance, there may be employed a method comprising the steps of mixing and agitating a solvent and fine particles to thus prepare a dispersed solution of fine particles beforehand, adding the dispersed solution of fine particles to a small quantity of a cellulose acylate solution, agitating and dissolving the mixture, and additionally mixing the resultant solution to a main cellulose acylate dope solution. This method is a desirable preparation method, in view of superior dispersibility of silicon dioxide particles and difficulty in re-aggregation of silicon dioxide particles. In addition, there may be employed another method comprising the steps of adding a small quantity of a cellulose ester to a solvent, agitating and dissolving the cellulose ester, adding fine particles to the solution, dispersing the resultant solution with a disperser, and sufficiently mixing the resultant solution as a particle addition solution with a dope through use of an inline mixer. The present invention is not limited to these methods. A concentration of silicon dioxide required when silicon dioxide particles are mixed with a solvent and dispersed preferably falls within the range of 5 to 30 weight percent, more preferably within the range of 10 to 25 weight percent, and most preferably within the range of 15 to 25 weight percent. The higher the dispersion concentration, the lower the turbidity of the solution with respect to the content. As a result, the haze and the aggregates are improved, and hence the higher dispersion concentration is desirable. The final quantity of mat agent in a dope of cellulose acylate falls preferably within the range of 0.01 to 1.0 g, more preferably within the range of 0.03 to 0.3 g, and most preferably within the range of 0.08 to 0.16 g.

Lower alcohols used for the solvent include desirably methyl alcohol, ethyl alcohol, propyl alcohol, isopropyl alcohol, butyl alcohol, and the like. No particular limitations are imposed on materials other than the lower alcohols. However, use of a solvent employed in manufacturing cellulose ester is desirable.

An organic solvent into which cellulose acylate of the present invention is dissolved will now be described.

### (Chlorine-based Solvent)

A chlorine-based organic solvent is preferably used as a principal solvent at the time of preparation of a solution of a cellulose acylate of the present invention. In the present invention, no specific limitations are imposed on the type of chlorine-based organic solvent within the range where a cellulose acylate can be dissolved, drawn, and formed into a film, so long as this objective can be achieved. The chlorine-based organic solvent is preferably dichloromethane and chloroform. Dichloromethane is particularly preferable. Moreover, mixing of an organic solvent other than the chlorine-based organic solvent does not pose any problem. In that case, use of at least 50 weight percent of dichloromethane is required. A non-chlorine-based organic solvent used in combination with the chlorine-based organic solvent in the present invention will now be described hereunder. Specifically, a solvent is selected from the group comprising ester, ketone, ether, alcohol, and hydrocarbon, each having 3 to 12 carbon atoms. Ester, ketone, ether, and alcohol may have a ring structure. A compound having any two or more functional groups (i.e., —O—, —CO—, and —COO—) of ester, ketone, and ether can also be used as a solvent. For example, the compound may simultaneously have another functional group such as an alcoholic hydroxyl group. In the case of a solvent having two or more types of functional groups, the only requirement is that the number of carbon atoms of the solvent must fall within a specific range of a compound having any of functional groups. Examples of esters having 3 to 12 carbon atoms include ethylformate, propylformate, pentylformate, methyl acetate, ethyl acetate, pentyl acetate, and the like. Examples of ketones having 3 to 12 carbon atoms include acetone, methylethyl ketone, diethyl ketone, diisobutyl ketone, cyclopentanone, cyclohexanone, and methylcyclohexanone. Examples of ethers having 3 to 12 carbon atoms include diisopropyl ether, dimethoxymethane, dimethoxyethane, 1,4-dioxane, 1,3-dioxolane, tetrahydrofuran, anisole, and phenetole. Examples of organic solvents having two or more types functional groups include 2-ethoxyethyl acetate, 2-methoxyethanol, and 2-butoxyethanol.

The alcohol used in conjunction with the chlorine-based organic solvent may preferably have a straight chain structure, a branched structure, or a ring structure. Of the alcohols, saturate aliphatic hydrocarbon is preferable. A hydroxyl group of alcohol may be any one of a primary alcohol to a tertiary alcohol. Examples of alcohol include methanol, ethanol, 1-propanol, 2-propanol, 1-butanol, 2-butanol, t-butanol, 1-pentanol, 2-methyl-2-butanol, and dichrohexanol. A fluorine-based alcohol may also be used as the alcohol. For instance, the fluorine-based alcohol includes 2-fluoroethanol, 2,2,2-trifluoroethanol, and 2,2,3,3-tetrafluoroethanol-1-propanol. The hydrocarbon may have a straight chain structure, a branched structure, or a ring structure. Either of aromatic hydrocarbon and aliphatic hydrocarbon can be used. The aliphatic hydrocarbon may be saturated or unsaturated. Examples of hydrocarbon include cyclohexane, hexane, benzene, toluene, and xylene.

Combinations of chlorine-based organic solvents which act as preferred principal solvents of the present invention may include the following combinations. However, the combinations are not limited to these.

The combinations include
Dichloromethane/methanol/ethanol/butanol (75/10/5/5/5 parts by weight),
Dichloromethane/acetone/methanol/propanol (80/10/5/5 parts by weight),
Dichloromethane/methanol/butanol/cyclohexane (75/10/5/5/5 parts by weight),
Dichloromethane/methyl ethyl ketone/methanol/butanol (80/10/5/5 parts by weight),
Dichloromethane/acetone/methyl ethyl ketone/ethanol/isopropanol (75/8/5/5/7 parts by weight),
Dichloromethane/cyclopentanone/methanol/isopropanol (80/7/5/8 parts by weight),
Dichloromethane/methyl acetate/butanol (80/10/10 parts by weight),
Dichloromethane/cyclohexanone/methanol/hexane (70/20/5/5 parts by weight),
Dichloromethane/methyl ethyl ketone/acetone/methanol/ethanol (50/20/20/5/5 parts by weight),
Dichloromethane/1,3-dioxolanes/methanol/ethanol (70/20/5/5 parts by weight),
Dichloromethane/dioxane/acetone/methanol/ethanol (60/20/10/5/5 parts by weight),
Dichloromethane/acetone/cyclopentanone/ethanol/isobutanol/cyclohexane (65/10/10/5/5/5 parts by weight),
Dichloromethane/methyl ethyl ketone/acetone/methanol/ethanol (70/10/10/5/5 parts by weight),
Dichloromethane/acetone/ethyl acetate/ethanol/butanol/hexane (65/10/10/5/5/5 parts by weight),
Dichloromethane/acetoacetic methyl/methanol/ethanol (65/20/10/5 parts by weight), and
Dichloromethane/cyclopentanone/ethanol/butanol (65/20/10/5 parts by weight).

### (Non-chlorine-based Solvent)

A non-chlorine organic solvent preferably used at the time of formation of a solution of a cellulose acylate of the present invention will now be described. In the present invention, no specific limitations are imposed on the type of non-chlorine-based organic solvent within the range where a cellulose acylate can be dissolved, drawn, and formed into a film, so long as this objective can be achieved. A solvent selected from the group comprising ester, ketone, and ester, each having 3 to 12 carbon atoms, is preferred as a non-chlorine-based organic solvent used in the invention. Ester, ketone, and ether may have a ring structure. A compound having any two or more functional groups (i.e., —O—, —CO—, and —COO—) of ester, ketone, and ether can also be used as the principal solvent. For example, the compound may have another functional group such as an alcoholic hydroxyl group. In the case of the principal solvent having two or more types of functional groups, the only requirement is that the number of carbon atoms of the solvent must fall within a specific range of a compound having any of functional groups. Examples of esters having 3 to 12 carbon atoms include ethylformate, propylformate, pentylformate, methyl acetate, ethyl acetate, and pentyl acetate. Examples of ketones having 3 to 12 carbon atoms include acetone, methylethyl ketone, diethyl ketone, diisobutyl ketone, cyclopentanone, cyclohexanone, and methylcyclohexanone. Examples of ethers having 3 to 12 carbon atoms include diisopropyl ether, dimethoxymethane, dimethoxyethane, 1,4-dioxane, 1,3-dioxolane, tetrahydrofuran, anisole, and phenetole. Examples of organic solvents having two or more types of functional groups include 2-ethoxyethyl acetate, 2-methoxyethanol, and 2-butoxyethanol.

Although the foregoing non-chlorine-based organic solvent used in conjunction with cellulose acylate is selected from the above-mentioned various viewpoints, the non-chlorine-based organic solvent is preferably selected as follows: Specifically, a preferable solvent of cellulose acylate of the present invention is a mixed solvent consisting of three or more different solvents. A first solvent is at least one type of substance selected from the group comprising methyl acetate, ethyl acetate, methyl formate, ethyl formate, acetone, dioxolane, and dioxane, or a mixture thereof. A second solvent is selected from ketones having 4 to 7 carbon atoms or acetoacetic esters. A third solvent is selected from alcohols having 1 to 10 carbons or hydrocarbons. More preferably, the third solvent is an alcohol having 1 to 8 carbons. When the first solvent is a mixture of two or more types of solvents, the second solvent may be obviated. The first solvent is more preferably methyl acetate, acetone, methyl formate, ethyl formate, or a mixture thereof. The second solvent is preferably methyl ethyl. ketone, cyclopentanone, cyclohexanone, acetyl methyl acetate, or a mixture thereof.

The alcohol acting as the third solvent may preferably have a straight chain structure, a branched structure, or a ring structure. Of the alcohols, saturated aliphatic hydrocarbon is preferable. A hydroxyl group of alcohol may be any one of a primary alcohol to a tertiary alcohol. Examples of alcohol include methanol, ethanol, 1-propanol, 2-propanol, 1-butanol, 2-butanol, t-butanol, 1-pentanol, 2-methyl-2-butanol, and dichrohexanol. A fluorine-based alcohol is also used as the alcohol. For instance, the fluorine-based alcohol includes 2-fluoroethanol, 2,2,2-trifluoroethanol, and 2,2,3,3-tetrafluoroethanol-1-propanol.

The hydrocarbon serving as the third solvent may have a straight chain structure, a branched structure, or a ring structure. Either of aromatic hydrocarbon and aliphatic hydrocarbon can be used. The aliphatic hydrocarbon may be saturated or unsaturated. Examples of hydrocarbon include cyclohexane, hexane, benzene, toluene, and xylene. The alcohol and the hydrocarbon, which serve as the third solvent, may be used solely or in the form of a mixture consisting of two or more types of compounds.

Alcohols of specific compounds which are preferable as the third solvent include methanol, ethanol, 1-propanol, 2-propanol, 1-butanol, 2-butanol, dichrohexanol, cyclohexanone, and hexane. Methanol, ethanol, 1-propanol, 2-propanol, and 1-butanol are particularly preferable compounds for the third solvent.

The three types of mixed solvents preferably contain 20 to 95 weight percent of the first solvent, 2 to 60 weight percent of the second solvent, and 2 to 30 weight percent of the third solvent. Additionally, the mixed solvents preferably contain 30 to 90 weight percent of the first solvent, 3 to 50 weight percent of the second solvent, and 3 to 25 weight percent of the alcohol made of the third solvent. Particularly, the mixed solvents preferably contain 30 to 90 weight percent of the first solvent, 3 to 30 weight percent of the second solvent, and 3 to 15 weight percent of the third solvent made of alcohol. When the first solvent does not employ the second solvent to make a mixed solution, the mixed solvents preferably contain a ratio of 20 to 90 weight percent of the first solvent to 5 to 30 weight percent of the third solvent. More preferably, the mixed solvents contain 30 to 86 weight percent of the first solvent and 7 to 25 weight percent of the third solvent. The non-chlorine-based organic solvent employed in the present invention is described in more detail in pp. 12 to 16 of the Journal of Technical Disclosure (Journal of Technical Disclosure No. 2001-1745, issued on Mar. 15, 2001, Japan Institute of Innovation and Invention). Preferred combinations of non-chlorine-based organic solvents of the present invention can be provided below. However, combinations of the non-chlorine-based organic solvents are not limited to those provided below.
Methyl acetate/acetone/methanol/ethanol/butanol (75/10/5/5/5 parts by weight)
Methyl acetate/acetone/methanol/ethanol/propyl alcohol (75/10/5/5/5 parts by weight)
Methyl acetate/acetone/methanol/butanol/cyclohexane (75/10/5/5/5 parts by weight)
Methyl acetate/acetone/ethanol/butanol (81/8/7/4 parts by weight)
Methyl acetate/acetone/ethanol/butanol (82/10/4/4 parts by weight)
Methyl acetate/acetone/ethanol/butanol (80/10/4/6 parts by weight)
Methyl acetate/methyl ethyl ketone/methanol/butanol (80/10/5/5 parts by weight)
Methyl acetate/acetone/methyl ethyl ketone/ethanol/isopropanol (75/8/5/5/7 parts by weight)
Methyl acetate/cyclopentanone/methanol/isopropanol (80/7/5/8 parts by weight)
Methyl acetate/acetone/butanol (85/10/5 parts by weight)
Methyl acetate/cyclopentanone/acetone/methanol/butanol (60/15/14/5/6 parts by weight)
Methyl acetate/cyclohexanone/methanol/hexane (70/20/5/5 parts by weight)
Methyl acetate/methyl ethyl ketone/acetone/methanol/ethanol (50/20/20/5/5 parts by weight)
Methyl acetate/1,3-dioxolane/methanol/ethanol (70/20/5/5 parts by weight)
Methyl acetate/dioxane/acetone/methanol/ethanol (60/20/10/5/5 parts by weight)
Methyl acetate/acetone/cyclopentanone/ethanol/isobutanol/cyclohexane (65/10/10/5/5/5 parts by weight)
Methyl formate/methyl ethyl ketone/acetone/methanol/ethanol (50/20/20/5/5 parts by weight)
Methyl formate/acetone/ethyl acetate/ethanol/butanol/hexane (65/10/10/5/5/5 parts by weight)
Acetone/methyl acetoacetata/methanol/ethanol (65/20/10/5 parts by weight)
Acetone/cyclopentanone/ethanol/butanol (65/20/10/5 parts by weight)
Acetone/1,3-dioxolane/ethanol/butanol (65/20/10/5 parts by weight)
Acetone/1,3-dioxolane/cyclohexanone/methyl ethyl ketone/methanol/butanol (55/20/10/5/5/5 parts by weight).

In addition, a solution of a cellulose acylate can also be used according to any of the following methods.

A method for preparing a solution of a cellulose acylate from methyl acetate/acetone/ethanol/butanol (81/8/7/4 parts by weight), and adding 2 parts by weight of butanol to the solution after filtration and condensation of the solution.

A method for preparing a solution of a cellulose acylate from methyl acetate/acetone/ethanol/butanol (84/10/4/2 parts by weight), and adding 4 parts by weight of butanol to the solution after filtration and condensation of the solution.

A method for preparing a solution of a cellulose acylate from methyl acetate/acetone/ethanol/butanol (84/10/6 parts by weight), and adding 5 parts by weight of butanol to the solution after filtration and condensation of the solution.

In addition to containing the non-chlorine-based organic solvents of the present invention, the dope used in the present invention may contain dichloromethane in an amount of 10 weight percent or less of the entire quantity of organic solvents.

### (Property of the Cellulose Acylate Solution)

A cellulose acylate of the present invention is characterized as a solution in which 10 to 30 weight percent of cellulose acylate is dissolved in an organic solvent. More preferably, cellulose acylate is a solution in which 13 to 27 weight percent of cellulose acylate is dissolved in an organic solvent. Particularly, cellulose acylate is a solution in which 15 to 25 weight percent of cellulose acylate is dissolved in an organic solvent. A method for adjusting cellulose acylate to these concentrations may be fulfilled such that a predetermined concentration is achieved in a stage where cellulose acylate is dissolved. Alternatively, the method may also be fulfilled such that a cellulose acylate solution is prepared as a low-density solution (of, e.g., 9 to 14 weight percent) in advance and such that the solution may be adjusted to a predetermined high-density solution through a condensing process to be described later. In addition, the method may also be fulfilled such that a high-density cellulose acetate solution is prepared in advance and such that a predetermined low-density cellulose acylate solution is prepared by addition of various additives. No problem is raised, so long as the concentration of cellulose acylate solution of the present invention is achieved by any of these methods.

Next, in the present invention, an aggregate molecular weight of cellulose acylate of a diluted solution, where the cellulose acylate solution is diluted to 0.1 to 5 weight percent by an organic solvent of single composition, preferably falls within the range of 150,000 to 15,000,000. More preferably, the aggregate molecular weight falls within the range of 180,000 to 9,000,000. This aggregate molecular weight can be determined by a static light scattering method. The cellulose acylate is preferably dissolved such that an inertia square radius determined simultaneously at that time falls within the range of 10 to 200 nm. A more desirable inertia square radius falls within the range of 20 to 200 nm. In addition, the cellulose acylate is dissolved such that a second virial coefficient falls within the range of −2×10⁻⁴ to 4×10⁻⁴. More preferably, the second virial coefficient falls within the range of −2×10⁻⁴ to 2×10⁻⁴.

The definition of the aggregate molecular weight, that of the inertia square radius, and that of the second virial coefficient, all being employed in the present invention, will be described hereunder. They were measured through use of the static light scattering method in accordance with the following method. For the sake of convenience of equipment, measurement was performed in a diluted area. Measured values reflect the behavior of the dope in the high-density area of the invention. First, cellulose acylate was dissolved in a solvent used for a dope, thereby preparing 0.1 weight percent of solution, 0.2 weight percent of solution, 0.3 weight percent of solution, and 0.4 weight percent of solution. In order to prevent occurrence of absorption, the cellulose acylate dried at 120° C. for two hours was used for weighing, and weighing of the cellulose acylate was carried out at 25° C. and 10% RH. The dissolving method was fulfilled according to the methods adopted at the time of dissolution of a dope (i.e., the ordinary-temperature dissolving method, the cooling dissolving method, and the high-temperature dissolving method). Subsequently, the solutions and solvents were filtrated through use of a filter made of Teflon (Registered Trademark). Static scattering light arising in the thus-filtrated solution was measured at 25° C. at spacings of ten degrees, from 30 to 140 degrees, with a light scattering measurement apparatus (DLS-700 of Otsuka electronic Ltd.). The thus-obtained data were analyzed by means of the BERRY plotting method. A refractive index of a solvent determined by an Abbe refraction system was used as a refractive index required for analysis. A concentration gradient (dn/dc) of the refractive factor was measured, through use of the solvent and solution used for measuring scattering light and a differential refractometer (DRM-1021 of Otsuka Electronic Ltd.).

### (Preparation of Dope)

Preparation of a cellulose acylate solution (dope) of the present invention is not limited to any specific dissolution method. Preparation of a cellulose acylate solution may be performed at room temperature. Further, the cellulose acylate solution can be prepared by the cooling dissolution method, the high-temperature dissolution method, or a mixture thereof. Methods for preparing the cellulose acylate solution are described in, e.g., JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017, and JP-A-11-302388. The above-described methods of dissolving cellulose acylate into an organic solvent can be adopted as appropriate in the present invention. Details of the descriptions are implemented by the method described in detail on pp. 22 to 25 of Journal of Technical Disclosure issued by Japan Institute of Invention and Innovation (Journal of Technical Disclosure No. 2001-1745 issued on Mar. 15, 2001, Japan Institute of Invention and Innovation). The dope solution of cellulose acylate of the present invention is usually subjected to solution condensation and filtration, which is similarly described in detail on pg. 25 of Journal of Technical Disclosure issued by Japan Institute of Invention and Innovation (Journal of Technical Disclosure No. 2001-1745 issued on Mar. 15, 2001, Japan Institute of Invention and Innovation). When cellulose acylate is dissolved at high temperature, the cellulose acylate is dissolved, in most cases, at a temperature which is higher than the boiling point of an organic solvent used for dissolution. In such a case, the organic solvent is used in a pressurized state.

In relation to the solution of the cellulose acylate of the present invention, the viscosity and dynamic storage modulus of the solution preferably fall within given ranges. 1 mL of sample solution was subjected to measurement through use of Steel Cone (manufactured by TA Instruments) having a diameter of 4 cm/2° set in a rheometer (CLS 500 manufactured by TA Instruments). Measurement requirements comply with Oscillation Step/Temperature Ramp. Measurement was performed while a temperature was varied at 2° C./min. over the range of −10° C. to 40° C., thereby determining a static non-Newton viscosity n*(Pa·s) at 40° C. and the storage modulus G′(Pa) at −5° C. Measurement was commenced after the sample solution had been thermally insulated in advance such that the temperature of the solution became constant at a measurement initiation temperature. In the present invention, preferred viscosity at 40° C. is 1 to 400 Pa·s; preferred dynamic storage modulus at 15° C. is 500 Pa or more; much preferred viscosity is 10 to 200 Pa·s; and much preferred dynamic storage modulus at 15° C. is 1000 to 1,000,000 Pa. When a support is at −50° C., preferred dynamic storage modulus is 10,000 to 5,000,000 Pa.

As mentioned previously, the density of the cellulose acylate solution is characterized in that a high-density dope is obtained. A high-density cellulose acylate solution having high stability is obtained without dependence on means, such as condensation. In order to facilitate solution of cellulose acylate, cellulose acylate may be dissolved at a low concentration, and the thus-prepared solution may be condensed through use of condensation means. No particular limitation is imposed on the condensation method. For instance, the method can be implemented according to one method (described in the specification of, e.g., JP-A-4-259511) or other methods (described in, e.g., U.S. Pat. Nos. 2,541,012, 2,858,229, 4,414,341, and 4,504,355), or like methods. According to the former method, a low-density solution is introduced into a space between a cylinder and a rotational locus of an outer periphery of rotary vanes which are provided in the cylinder and rotate in a circumferential direction, whereby a high-density solution is prepared by imparting a temperature difference to the solution to thus evaporate a solvent. According to the other methods, a heated low-density solution is blown into a container from a nozzle, and a solvent is subjected to flash evaporation during a period of time in which the solution ejected from the nozzle comes into collision with an interior wall of the container. The thus-evaporated solvent is purged from the container, whereupon a high-density solution is drained out from the bottom of the container.

Before flow-casting of the solution, extraneous matters, such as undissolved substances, dusts, and impurities, are preferably removed through filtration through use of an appropriate filter medium such as a wire net or flannel. An absolute filtration accuracy of 0.1 to 100 μm is used for filtering the cellulose acylate solution, and use of a filter having an absolute filtration accuracy of 0.2 to 2 μm is more preferable. In that case, filtration is preferably performed under a filtration pressure of 16 kgf/cm² or less, more preferably a filtration pressure of 12 kgf/cm² or less, much more preferably a filtration pressure of 10 kgf/cm² or less, and most preferably a filtration pressure of 2 kgf/cm² or less. Conventionally-known materials, such as a glass fiber, a cellulose fiber, filter paper, or fluororesin like a polytetrafluoroethylene resin, can be used as a filter medium. Particularly preferably, ceramics and metal are used. The sole requirement in relation to the viscosity of cellulose acylate solution achieved immediately before formation of a film must fall within a range in which the solution can be cast during formation of a film. The cellulose acylate solution is preferably adjusted so as to fall within a normal range of 10 Pa·s to 2000 Pa·s, more preferably a range of 30 Pa·s to 1000 Pa·s, and much more preferably a range of 40 Pa·s to 500 Pa·s. No limitations are imposed on the temperature required at this time, so long as the temperature is the temperature adopted for flow-casting the solution. Preferably, the temperature falls within the range of −5° C. to 70° C., and more preferably within the range of −5° C. to 55° C.

### (Formation of a Film)

The manufacturing method of the film that uses the cellulose acylate solution is described. A solution flow-casting film formation method and a solution flow-casting film formation apparatus, which are used for manufacturing a conventional cellulose acetate film, are used as a method and facility for manufacturing a cellulose acylate film of the present invention. A dope (cellulose acylate solution) prepared in a dissolver (pot) is temporarily stored in a storage pot, where bubbles contained in the dope are defoamed, to thus finally prepare the dope. The dope is delivered to a pressure die from a dope outlet port by way of a pressure metering gear pump capable of delivering a constant quantity of fluid with high accuracy by means of adjusting, e.g., the number of rotations. The dope is uniformly flow-cast on a metal support of a flow-cast section which runs endlessly from a ferrule (slit) of the pressure die. At a point in time when the metal support has made essentially one rotation, a damp-dry dope film (also called a web) is exfoliated from the metal support. Both ends of the thus-obtained web are nipped with clips and dried while being transported by a tenter. Subsequently, the web is transported by means of a group of rollers of a drier, whereby drying of the web is completed. The thus-dried web is taken up to a predetermined length by means of a winding machine. A combination of the tenter and the drier of the roller group is selected according to an objective. In a solution flow-cast film formation method used for forming a silver halide photosensitive material and a functional protective film for an electronic display, an applicator is often provided for subjecting films, such as an undercoating layer, an antistatic layer, an antihalation layer, and a protective film, to surface treatment, in addition to the solution flow-cast film formation apparatus. Individual manufacturing processes will be briefly described hereunder. However, the present manufacturing method is not limited to these processes.

The prepared cellulose acylate solution (dope) is flow-cast over a drum or a band before being used for forming a cellulose acylate film according to the solvent cast method, thereby evaporating the solvent to form a film. Before being flow-cast, the dope is preferably subjected to density control such that a solid content assumes a value of 5 to 40 weight percent. Further, the surface of the drum or band is preferably mirror-finished beforehand. The dope is preferably flow-cast over the drum or band having a surface temperature of 30° C. or less. A metal support having a surface temperature of −10 to 20° C. is particularly preferable. Moreover, techniques described in the following official gazettes can be applied to the present invention; for example, JP-A-2000-301555, JP-A-2000-301558, JP-A-07-032391, JP-A-03-193316, JP-A-05-086212, JP-A-62-037113, JP-A-02-276607, JP-A-55-014201, JP-A-02-11151, and JP-A-02-208650.

### (Multilayer Flow-cast)

The cellulose acylate solution may be flow-cast over a smooth band or drum used as the metal support in the form of a single layer fluid, or the cellulose acylate solution may be flow-cast in the form of two or more layers. When the cellulose acylate solution is flow-cast into a plurality of layers, a solution containing cellulose acylate may be flow-cast into lamination of layers from a plurality of flow ports provided at intervals in the advancing direction of the support, thereby forming a film. For example, methods described in JP-A-61-158414, JP-A-1-122419 and JP-A-11-198285 can be used.

Moreover, a film can be formed by means of causing the cellulose acylate solution to flow-cast from two flow ports. For example, methods described in JP-B-60-27562, JP-A-61-94724, JP-A-61-947245, JP-A-61-104813, JP-A-61-158413, and JP-A-6-134933 can be used. A cellulose acylate film flow-cast method described in JP-A-56-162617 can also be used, wherein a flow of high-viscosity cellulose acetate solution is shrouded by a low-viscosity cellulose acetate solution, and the high-viscosity and low-viscosity cellulose acetate solutions are squirted simultaneously. In addition, as described in official gazettes such as JP-A-61-94724 and JP-A-61-94725, a technique for causing an outer solution to contain a much greater amount of an alcohol composition, which is a poor solvent, than does an inner solution, is also a preferred mode. Alternatively, a film can also be formed by use of two flow ports; scraping a film formed on the support by means of a first flow port; and flow-casting the solution over the surface of the film contacting the surface of the support by means of second flow-casting operation. For instance, a method described in JP-B-44-20235 can be given. The cellulose acylate solution to be flow-cast may be embodied by a single cellulose acetate solution or different cellulose acetate solutions. In order to impart functions to a plurality of cellulose acylate layers, the only requirement is to squirt from the respective flow ports cellulose acylate solutions corresponding to the functions. The cellulose acylate solution can also be flow-cast concurrently with another functional layer (e.g., an adhesive layer, a pigment layer, an antistatic layer, an antihalation layer, an ultraviolet absorptive layer, a polarizing layer, or the like).

In the case of a prior-art single-ply solution, a high-viscosity cellulose acetate solution must be squirted in order to achieve a required film thickness. In this case, the stability of the cellulose acylate solution is poor, and hence solids arise, which induces problems, such as breakdown or a planarity failure. One means of resolution of this problem is to cast a plurality of flows of cellulose acylate solutions from the flow ports. As a result, the high-viscosity solutions can be concurrently squirted over the support, whereby a planar film having improved planarity can be formed. In addition, a drying load can be diminished through use of a thick cellulose acylate solution, thereby increasing the manufacturing speed of a film. In the case of co-flow-casting operations, no limitations are imposed on thicknesses of inner and outer films. The outer film preferably accounts for 1 to 50% of the overall film thickness, more preferably 2 to 30%. Here, in the case of co-flow-casting operation of three or more layers, the total thickness of a film consisting of a layer contacting the metal support and the layer contacting air is defined as the outer thickness. In the case of co-flow-casting operation, cellulose acylate solutions doped with different concentrations of the previously-described plasticizer, ultraviolet absorber, or a mat agent are flow-cast, whereby a cellulose acylate film having a laminate structure can be manufactured. For instance, a cellulose acylate film having a constitution of a skin layer/a core layer/a skin layer can be formed. The skin layer can be formed to contain a larger amount of mat agent, or the mat agent can be put solely in the skin layer. Further, the plasticizer and the UV-radiation absorber can be put in larger quantity into the core layer than in the skin layer, or only in the core layer. The type of the plasticizer and that of the ultraviolet absorber can also be changed between the core layer and the skin layer. For instance, the skin layer can be doped with a low-volatility plasticizer, a UV-radiation absorber, or both; and the core layer can be doped with a plasticizer having superior plasticity, or an ultraviolet absorber having a superior UV absorbing property. Moreover, impregnating only the skin layer provided on the metal support with a releasing agent is also desirable mode. Addition of a larger amount of alcohol serving as a poor solvent to the skin layer with a view toward gelating the solution by cooling the metal support according a cool drum method is also preferable. The skin layer may differ from the core layer in terms of Tg, and Tg of the skin layer is preferably lower than Tg of the core layer. The skin layer is preferably lower in Tg than the core layer. The viscosity of the solution containing cellulose acylate achieved at the time of flow-casting operation may vary from the skin layer to the core layer. The skin layer is preferably lower in viscosity than the core layer. However, the core layer may be lower in viscosity than the skin layer.

### (Flow-cast)

Preferred methods for flow-casting a solution include a method for squirting the prepared dope uniformly over the metal support from the pressure die, a doctor blade method for controlling a film thickness of the dope flow-cast over the metal support by means of a doctor blade, and a reverse roller coater method for controlling a film thickness by means of a reversely-rotating roller. Of these methods, the method using the pressure die is preferable. The pressure die includes a pressure die of coat-hanger type or a pressure die of T-die type, and either of these dies can be preferably used. Flow casting can be performed by various conventionally-known methods for forming a film by flow-casting a cellulose acylate solution other than those mentioned above. Advantages which are analogous to those described in the respective official gazettes can be yielded by means of setting requirements in consideration of a difference between boiling points of solvents used or like factors. A drum whose surface is mirror-finished through chromium plating or a mirror-finished stainless belt (may also be called a “band”) is used as the metal support which is used for manufacturing the cellulose acylate film of the present invention and runs endlessly. In relation to the pressure die used in manufacturing the cellulose acylate film of the present invention, one or two sets of pressure dies may be positioned at an elevated position(s) above the metal support. One or two sets of pressure dies are preferable. When two or more sets of pressure dies are disposed, the quantity of dopes flow-cast into the dies may be set in various proportions. The dope may be delivered to the respective dies in those proportions from a plurality of precision metering gear pumps. The temperature of the cellulose acylate solution used for flow-casting preferably falls within the range of −10 to 55° C., and more preferably the range of 25 to 50° C. In that case, all the processes may be identical or may vary from one location to another. The only requirement in the case where the processes may change is that the dope is at a desired temperature immediately before flow-casting.

### (Drying)

Drying of the dope cast over the metal support associated with manufacture of the cellulose acylate film is performed by the following methods. Under one method, hot air is generally blown over the web provided on the surface of the metal support (the drum or belt); i.e., the web situated on the metal support. Under a back surface fluid heat transfer method, a temperature-controlled fluid is brought into contact with a back surface on the side opposite the surface of the drum or belt covered with the flow-cast dope, and the drum or belt is heated by heat transfer, to thus control the surface temperature. Here, the back surface fluid heat transfer method is preferable. The surface of the metal support before being subjected to flow-casting may assume any temperature, so long as the temperature is equal to or lower than the boiling point of the solvent used in the dope. However, in order to promote drying action or to deprive the dope on the metal support of fluidity, the surface temperature of the metal support is preferably set to a temperature which is lower than the boiling point of a solvent, the boiling point being lowest among the boiling points of the other solvents, by 1 to 10 degrees, except when the flow-cast dope is exfoliated without cooling or drying.

### (Drawing)

Retardation of the cellulose acylate film of the present invention can be adjusted by means of drawing. Moreover, there may be employed a method for actively stretching the cellulose acylate film in a widthwise direction. The method is described in official gazettes; e.g., JP-A-62-115035, JP-A-4-152125, JP-A-4-284211, JP-A-4-298310, and JP-A-11-48271. Under this method, an in-plane retardation value of the cellulose acylate film is made high, and hence a manufactured film is drawn.

Drawing of the film is performed at room temperature or under heated conditions. The heating temperature is preferably the glass-transition temperature of the film or less. The film may be subjected to uniaxial drawing in only a longitudinal or lateral direction, or simultaneously or consecutively subjected to biaxial drawing. Drawing is performed at a rate of 1 to 200%. Drawing of a film at a rate of 1 to 100% is preferable. Drawing of a film by 1 to 50% is especially preferable. In relation to birefringence of the optical film, a refractive factor in a widthwise direction is preferably larger than that in a longitudinal direction. Accordingly, the film is preferably drawn greatly in the widthwise direction. Drawing operation may be performed during the course of manufacture of a film, or an original fabric taken up after having been formed into a film may be subjected to drawing. In the former case, the film may be stretched while containing a residual solvent content. The film is preferably drawn within a residual solvent content range of 2 to 30%.

The thickness of the finished cellulose acylate film of the present invention changes according to the objective of usage. The thickness usually falls within the range of 5 to 500 μm, more preferably within the range of 20 to 300 μm, and most preferably within the range of 30 to 150 μm. The thickness of the cellulose acylate film for use with a VA liquid crystal display preferably falls within the range of 40 to 110 μm. The film is prepared by controlling a solid content included in the dope, the spacing between slits of the ferrule of the die, the pressure used for squiring the dope from the die, and the speed of the metal support, such that the filweightumes a desired thickness. The width of the thus-formed cellulose acylate film falls preferably within the range of 0.5 to 3 m, more preferably 0.6 to 2.5 m, and further preferably 0.8 to 2.2 m. The film is preferably wound to a length of 100 to 10000 m per roll, preferably a length of 500 to 7000 m per roll, and most preferably a length of 1,000 to 6,000 m. Knurling is preferably imparted to at least one side of the film during the course of winding of the film. The width of knurling preferably falls within the range of 3 mm to 50 mm and preferably within the range of 5 mm to 30 mm. The height of the knurling falls preferably within the range of 0.5 to 500 μm and more preferably within the range of 1 to 200 μm. The knurling may be effected by single action or double action. Variations in a Re value of the entire width preferably fall within the range of +5 nm, and more preferably within the range of ±3 nm. Variations in an Rth value of the entire width preferably fall within the range of ±10 nm, and more preferably within the range of ±5 nm. Variations in the Re value and the Rth value in the longitudinal direction preferably fall within the range of variations in the widthwise direction.

### (Optical Characteristics of the Cellulose Acylate Film)

In relation to optical characteristics of the cellulose acylate film of the present invention, given Re(λ) and Rth(λ) defined by the following formulae (I) and (II):

Re(λ)=(nx−ny)×d, formula (I)

Rth(λ)={(nx+ny)/2−nz}×d. formula (II)

### The film preferably satisfies the following formulae (III) and (IV):

30 nm≦Re(590)≦200 nm, formula (III)

70 nm≦Rth(590)≦400 nm. formula (IV)

In these formulae, Re(λ) is a retardation value by nm in a film plane of the cellulose acylate film with respect to a light having a wavelength of λ nm; Rth(λ) is a retardation value by nm in a direction of thickness of the cellulose acylate film with respect to the light having the wavelength of λ nm; nx is a refractive index in a slow axis direction in the film plane; ny is a refractive index in a fast axis direction in the film plane; nz is a refractive index in the direction perpendicular the film plane; and d is a thickness of the cellulose acylate film.

More preferably, Re(λ) and Rth(λ) satisfy the following formulae (III′) and (IV′):

30 nm≦Re(590)≦100 nm, formula (III′)

70 nm≦Rth(590)≦200 nm. formula (IV′)

In addition, when the cellulose acylate film satisfies the following formula (V), a preferred advantage; that is, the capability to effect optical compensation, can be yielded by use of a single cellulose acylate film to either a view-side or backlight-side of the liquid crystal cell.

230≦Rth(590)≦300. Formula (V)

### (Equilibrium Moisture Content of Film)

Because the equilibrium moisture content of the cellulose acylate film of the present invention doesn't impair the adhesiveness of the film with a water-soluble polymer, such as polyvinyl alcohol, when used as a protective film of the polarizing plate, the equilibrium moisture content at 25° C. and 80% RH is preferably 0 to 3.2%, regardless of the thickness of film. The equilibrium moisture content preferably falls within the range of 0.1 to 3%, and more preferably within the range of 1 to 3%. If the equilibrium moisture content is equal to 3.2% or more, a change in retardation of the film due to a change in moisture will become excessively great, which in turn deteriorates optical compensation performance. For this reason, a large equilibrium moisture content is undesirable.

The moisture content was measured by the Karl Fischer technique by use of a cellulose acylate film sample of the present invention measuring 7 mm×35 mm, along with a moisture measurement instrument and a sample drier (CA-03, VA-05 of Mitsubishi Chemical Ltd.). The moisture content was determined by dividing a water content (g) by the weight of the sample (g).

### (Water-vapor Permeability of the Film)

The water-vapor permeability of the cellulose acylate film used for the optical compensation sheet of the present invention is measured under specific conditions; that is, a temperature of 40° C. and a humidity of 90% RH, and the result of measurement is converted into a film thickness of 80 λm. The water-vapor permeability preferably falls within the range of 300 to 1000 g/m²·24 hr, preferably within the range of 300 to 900 g/m²·24 hr, and most preferably within the range of 300 to 800 g/m²·24 hr. When the water-vapor permeability exceeds 1000 g/m²·24 hr, a change rate at which the retardation of the film changes under the influence of moisture becomes great, whereby the optical compensation performance is deteriorated. In the meantime, in a case where the water-vapor permeability is under 300 g/m²·24 hr, drying of an adhesive is hindered by the cellulose acylate film when a polarizing plate is formed by affixing the film on both sides of the polarizing film, thereby resulting in a bonding failure.

The greater the thickness of the cellulose acylate film, the smaller the water-vapor permeability. The smaller the film thickness, the greater the water-vapor permeability. For this reason, a standard film thickness is set to 80 μm for each sample, and the thickness of the sample must be converted. Conversion of a film thickness is performed (on condition of water-vapor permeability achieved at 80 μm=actually-measured water-vapor permeability×actually-measured film thickness μm/80 μm).

The method described in pp. 285 to 294 of “Physical Properties II of the Polymer” (Polymer Experiment Course 4, Kyoritsu Shuppan Co., Ltd.): Measurement of the Amount of Permeated Vapor (the weighing method, the thermometer method, the vapor pressure method, and the absorption amount method) can be applied to measurement of water-vapor permeability.

### (Haze of the Film)

The haze of the cellulose acylate film of the present invention preferably falls within the range of 0.01 to 2.0%, more preferably within the range of 0.05 to 1.5%, and most preferably within the range of 0.1 to 1.0%. When the haze is increased to 2% or more, the brightness of the liquid crystal cell is decreased when the film is affixed to a panel. For this reason, a haze of 2% or more is not desirable.

The haze was measured through use of a cellulose acylate film sample of the present invention measuring 40 mm×80 mm along with a haze meter (HGM-2DP of Suga Tester) at 25° C. and 60% RH in compliance with JIS K-6714.

### (Photoelastic Coefficient of the Cellulose Acylate Film)

The photoelastic coefficient is preferably 50×10⁻¹³ cm²/dyne or less, more preferably 30×10⁻¹³ cm²/dyne or less, and most preferably falls within the range from 10×10⁻¹³ cm²/dyne to 20×/10⁻¹³ cm²/dyne. A cellulose acylate film having a photoelastic coefficient of 50×10⁻¹³ cm²/dyne or more, even a polarizing plate whose optical performance and humidity conditions are optimized, is susceptible to occurrence of irregularities which involve leakage of light from surroundings or corners of a screen, thereby raising a problem of deterioration of display quality. In view of avoidance of this problem, the smaller photoelastic coefficient is desirable. When an attempt is made to achieve 10×10⁻¹³ cm²/dyne or less through use of the cellulose acylate film, heavy limitations are imposed on the types of available additives, the quantity of available additives, and the types of available acylates. Therefore, in many cases, difficulty is encountered in achieving desired optical performance or stable production.

The photoelastic coefficient of the film can be measured by imposing a given load, which falls within an elastic range, on the film and measuring the retardation of the film. In the present invention, five types of loads are selected within the range of 360 to 2400 g for a film measuring 1 cm width×10 cm, and the photoelastic coefficient of the film can be determined from a relationship between the loads and the retardation. Large variations exist under the small load ranging from 0 to 500 g and within a narrow range, so that accurate determination of the photoelastic coefficient is difficult.

### (Grass Transition Temperature)

The grass transition temperature of the cellulose acylate film of the present invention is preferably from 60 to 160° C., more preferably from 70 to 150° C., most preferably from 70 to 135° C. The glass transition temperature Tg of the cellulose acylate film can be determined by calorimetric measurement for the cellulose acylate film of 10 mg with a different scanning calorimeter (DSC2910 manufactured by T.A. Instruments) at a temperature rising rate of 5° C./min over a measurement temperature range of from normal temperature to 200° C.

### (Polarizing Plate)

The cellulose acylate film used for the polarizing plate of the present invention has been described thus far. Next will be described the polarizing plate of the present invention. As mentioned previously, the polarizing plate of the present invention is housed (or stored) in the moisture-proofed container.

The polarizing plate comprises a polarizer, and two transparent protective films provided on the respective sides thereof. The cellulose acylate film of the present invention can be used as one of the two protective films. An ordinary cellulose acetate film may be used as the other protective film. The above-mentioned polarizer includes an iodine-based polarizer, a dye-based polarizer using dichromatic dye, and a polyene-based polarizer. The iodine-based polarizer and the dye-based polarizer are generally manufactured through use of a polyvinylalcohol-based film. When the cellulose acylate film of the present invention is used as a polarizing plate protective film, no specific limitations are imposed on the method for manufacturing the polarizing plate. The cellulose acylate film can be formed by a general method. The thus-obtained cellulose acylate film is subjected to alkaline treatment, and the cellulose acylate film is affixed to both sides of the polarizer formed as a result of a polyvinyl alcohol film being immersed and stretched in an iodine solution, through use of a completely-saponified polyvinyl alcohol solution. Easy bonding, such as that described in JP-A-6-94915 and JP-A-6-118232, may be performed in lieu of alkaline treatment. The adhesive used for affixing the surface covered with the protective film to the polarizer includes a polyvinyl-alcohol-based adhesive such as polyvinyl alcohol or polyvinyl butyral, a vinyl-based latex such as butyl acrylate, or the like.

The polarizing plate comprises the polarizer, and the protective films protecting both sides of the polarizer. Further, a protective film is stuck (or affixed) on one side of the polarizing plate, and a separate film is affixed on the other side of the same. The protective film and the separate film are used for the purpose of protecting the polarizing plate at the time of shipment, inspection of a product, or like situations. In this case, the protective film is affixed for protecting the surface of the polarizing plate and provided on the surface of the polarizing plate opposite the other surface thereof to be affixed to the liquid crystal plate. The separate film is used for protecting an adhesive layer to be affixed to the liquid crystal plate and provided on the side of the polarizing plate to be affixed to the liquid crystal plate.

A preferred manner of affixing the cellulose acylate film of the present invention to the polarizer is to affix the film such that the transmission axis of polarizing plate is aligned with the lagging axis of the cellulose acylate film of the present invention. The thus-formed polarizing plate was evaluated while situated in the cross nicol disposition. The result of measurement shows that the polarization performance of the polarizing plate achieved while the polarizing plate is placed in the cross nicol disposition is deteriorated when orthogonal accuracy between the lagging axis of the cellulose acylate film of the present invention and the absorption axis of the polarizer (i.e., an axis perpendicular to the transmission axis) is greater than 1 degree, thereby causing leakage of light. Consequently, an offset between the direction of the principal refractive index nx of the cellulose acylate film and the direction of the transmission axis of the polarizing plate is 1° or less, preferably 0.5° or less.

### (Moisture-proofed Container)

In the present invention, the polarizing plate of the present invention is stored and reserved in a moisture-proofed container. The polarizing plate is taken out of the container, as required, and used as a result of being affixed (or stuck) to the panel of the liquid crystal display.

A “moisture-proofed bag” is preferable as the container for storing the polarizing plate of the present invention. This bag is specified by the water-vapor permeability measured in compliance with the cup method (JIS Z208). In the present invention, the “moisture-proofed bag” is defined as a bag made of a material whose water-vapor permeability measured at 40° C. and 90% RH according to the foregoing method is 30 g/(m²·Day). When the water-vapor permeability exceeds 30 g/(m²·Day), the influence of external environmental humidity on the bag cannot be prevented. The water-vapor permeability is more preferably 10 g/(m²·Day) or less, and most preferably 5 g/(m²·Day) or less.

No limitations are imposed on the material of the moisture-proofed container, and known materials can be used, so long as the materials satisfy the above-described water-vapor permeability (Packaging Material Handbook Japan Packing Institute (1995); “Basic Knowledge of Packaging Materials” Japan Packaging Institute (November, 2001); “Introduction to Functional Packaging”; and “Research Bounds of Package in the 21^{st} century (refer to the 1^{st} edition of the first copy, Feb. 28, 2002, etc.)).

In the present invention, a lightweight material which has low water-vapor permeability and is easy to handle is desirable. A film formed by depositing silica, alumina, ceramics materials, or the like on a plastic film or a composite material such as a laminate film consisting of a plastic film and an aluminum foil is particularly preferably used. No limitations are imposed on the thickness of the aluminum foil, so long as the internal humidity of the container is not changed by the environmental humidity at that thickness. The thickness preferably falls within the range of a few micrometers to hundreds of micrometers, and more preferably within the range of 10 μm to 500 μm.

The polarizing plate of the present invention is stored in the moisture-proofed container. The internal humidity of the container achieved at that time satisfies either of the following humidity conditions (i) and (ii).

(i) The humidity falls within the range of 40% RH to 65% RH at 25° C. while the polarizing plate is stored. The humidity preferably falls within the range of 45% RH to 65% RH.

(ii) The internal humidity of the container achieved when the polarizing plate is housed is 15% RH with respect to the humidity acquired when the polarizing plate is stuck to the liquid crystal panel.

Changes in the optical compensation function of the polarizing plate, which would arise after the plate has been affixed to the panel, can be reduced to a harmless level by means of satisfying any of the foregoing requirements.

### (Surface Treatment)

In some cases the cellulose acylate film of the present invention used as the protective film of the polarizing plate is subjected to surface treatment, thereby enhancing adhesiveness between the cellulose acylate film and the functional layers (e.g., an undercoating layer and a back layer) constituting the polarizing plate. For instance, glow discharge treatment, UV-radiation exposure treatment, corona discharge treatment, flame treatment, acidizing, and alkaline saponification treatment can be employed. The glow discharge treatment may be a low-temperature plasma which arises in a low-pressure gas of 10⁻³ to 20 Torr. Moreover, plasma treatment under atmospheric pressure is also preferable. A plasma excitation gas is a gas excited to a plasma under the foregoing conditions. The plasma excitation gas includes argon, helium, neon, krypton, xenon, nitrogen, carbon dioxide, and species of freon such as tetrafluoromethane, or a mixture thereof. These gases are described in detail on pp. 30 to 32 of Journal of Technical Disclosure published by Japan Institute of Innovation and Invention (Journal of Technical Disclosure Number 2001-1745, issued by Japan Institute of Innovation and Invention on Mar. 15, 2001). Radiation energy of 20 to 500 Kgy is used for plasma treatment at atmospheric pressure, which has recently attracted attention; at, for instance 10 to 1000 Kev. More preferably, radiation energy of 20 to 300 Kgy is used at 30 to 500 Kev more. Of these surface treatments, the alkaline saponification treatment is extremely effective as surface treatment for the cellulose acylate film.

The alkaline saponification treatment is preferably performed by means of a method for immersing the cellulose acylate film directly in a saponification solution, or a method for applying a saponification solution to the cellulose acylate film. The coating method includes a dip coating method, a curtain coating method, an extrusion coating method, a bar coating method, and an E-type coating method. A solvent—which has superior wettability and is to be utilized for applying the saponification solution to a transparent support and maintains a plane shape in a good condition without forming irregularities in the surface of the transparent support, which would otherwise be caused by the saponification solution—is preferably selected as a solvent for the alkaline saponification coating fluid. Specifically, an alcohol-based solvent is preferable, and isopropyl alcohol is particularly preferable. Alkaline to be dissolved in the solvent is preferable as alkaline of the alkaline saponification coating fluid. KOH and NaOH are more preferable. The saponification coating fluid preferably has a pH of 10 or more, more preferably a pH of 12 or more. Reaction of alkaline saponification is preferably carried out for 1 second to five minutes, more preferably five seconds to five minutes, and particularly preferably 20 seconds to three minutes. After alkaline saponification reaction, the surface coated with saponification coating fluid is preferably subjected to rinsing, or is rinsed after having been washed with an acid.

### (Antireflective Layer)

Provision of a functional film, such as an antireflective layer, on a transparent protective film disposed on the side opposite to the liquid crystal cell is preferable. Particularly, the present invention preferably employs an antireflective layer formed as a result of stacking at least the light scattering layer and a lower refractive layer, in this order, on the transparent protective film, or an antireflective layer formed as a result of stacking a medium refractive layer, a higher refractive layer, and a lower refractive layer, in this sequence, on the transparent protective film. Preferable examples of the antireflective layers will be hereunder described.

A preferred embodiment of the antireflective layer formed as a result of stacking the light scattering layer and the lower refractive layer on the transparent protective film will now be described.

Mat particles are dispersed over the light scattering layer of the present invention, and the refractive index of the material other than the mat particles of the light scattering layer preferably falls within the range of 1.50 to 2.00. The refractive index of the lower refractive layer falls preferably within the range of 1.35 to 1.49. The light scattering layer of the present invention has an antiglare property and a hard coating property. The light scattering layer may be a single layer or a plurality of layers; e.g., 2 to 4 layers.

In relation to surface irregularities, the antireflective layer is designed such that an arithmetical mean deviation of profile Ra falls within the range of 0.08 to 0.40 μm; such that 10-point average roughness Rz is 10 times Ra or less; such that a mean peak-to-valley distance Sm falls within the range of 1 to 100 μm; such that a standard deviation of a height of a bulge from the deepest portion of irregularities is 0.5 μm or less; such that a mean peak-to-valley distance Sm determined while a centerline is taken as a reference is 20 μm or less; and such that surfaces whose tilt angles range from 0 to 5 become 10% or more. A sufficient antiglare property and a visually uniform feeling of a mat are achieved, and hence such a design is preferred. The tint of reflected light under the light source C is an a*value from −2 to 2 and a b*value from −3 to 3, and a ratio between the minimum reflectivity to the maximum reflectivity within the range of 380 nm to 780 nm is 0.5 to 0.99. Therefore, the tint of the reflective light becomes neutral and preferred. Further, the b*value of the transmitted light under the C light source is set to 0 to 3, whereby the yellowish stint of a white display achieved when the antireflective layer is applied to a display device is preferably diminished. A grid measuring 120 μm×40 μm is inserted between the plane light source and the antireflective film of the present invention, and the distribution of brightness on a film is measured. When the standard deviation of the brightness distribution is 20 or less, variations, which would otherwise arise when the film of the present invention is applied to a high-resolution panel, are preferably diminished.

The optical properties of the antireflective layer of the present invention are set so as to achieve a specular reflectivity of 2.5% or less, a transmissivity of 90% or more, and a 60-degree glossiness of 70% or less, whereby reflection of external light can be suppressed to thus enhance visibility. Particularly, a specular reflectivity of 1% or less is more preferable, and a specular reflectivity of 0.5% or less is most preferable. Occurrence of glare on the high-resolution LCD panel and blurring of characters can be prevented, by means of setting a haze to 20% to 50%, an internal haze/total haze value to 0.3 to 1, a drop from the haze value of the light scattering layer to a haze value achieved after formation of the lower refractive layer to 15% or less, a visibility of the image transmitted through a comb having a width of 0.5 mm to 20% to 50%, and a transmissivity ratio of the vertical transmitted light to the light transmitted at an angle of 2 degrees with respect to the normal line to 1.5 to 5.0.

### (Lower Refractive Layer)

The refractive index of the lower refractive layer of the antireflective film of the present invention falls within the range of 1.20 to 4.49 and preferably within the range of 1.30 to 1.44. In view of a decrease in reflectivity, the lower refractive layer should preferably satisfy the following formula (VIII):

(m/4)×0.7<n1d1<(m/4)×1.3,

where “m” is a positive odd number, n1 is a refractive index of the lower refractive layer, and d1 is the thickness of the lower refractive layer. λ designates a wavelength which falls within the range of 500 to 550 nm.

A material forming the lower refractive layer of the present invention will be described below.

The lower refractive layer of the present invention contains fluorine polymer as a low refractive binder. Fluorine polymer—which has a kinetic friction coefficient of 0.03 to 0.20, a contact angle of 90 to 120° to water, and a slip angle of pure water of 70 degrees or less and which causes a crosslinking by means of heat or ionizing radiation—is preferable. When the antireflective film of the present invention is affixed to the image display device, an affixed seal or memo becomes easy to remove as the stripping force of a commercially-available adhesive tape is smaller. Stripping force of 500 gf or less is preferable, stripping force of 300 gf or less is more preferable, and stripping force of 100 gf or less is most preferable. The higher the surface roughness measured by a micro hardness meter, the more easily the antireflective film is flawed. A surface roughness of 0.3 GPa or more is preferable, and a surface roughness of 0.5 GPa or more is more preferable.

Fluorine polymer used for a lower refractive layer includes a product of hydrolysis of a perfluoroalkylate-group-containing silane compound [e.g., (heptadecafluoro-1,1,2,2-tetrahydrodecyl) triethoxysilane], a product of dehydrate condensation, and a fluorine copolymer containing, as constituent components, a fluorine monomer and a unit for imparting crosslinking reactivity.

Examples of the fluorine monomer include fluoroolefins (e.g., fluoroethylene, vinylidene fluoride, tetrafluoroethylene, perfluorooctylethylene, hexafluoropropylene, perfluoro-2,2-dimethyl-1,3-dioxole, etc.); a (meta) acrylic acid portion, complete fluorinated alkyl ester derivatives [e.g., Biscoat 6FM (trade name, Osaka Organic Chemical Industry Ltd.), M-2020 (Dailin Industries Ltd.)]; or complete/partial fluorine vinyl ethers. Perfluoroolefines are preferable, and hexafluoropropylene is particularly preferable, in view of refractive index, solubility, transparency, and easiness of procurement.

A constituent unit for imparting a crosslinking reaction property includes a constituent unit obtained as a result of polymerization of a monomer having a self-crosslinkable functional group provided beforehand in molecules as in the case of glycidil (meta) acrylate or glycidil vinyl ether; a constituent unit obtained as a result of polymerization of a monomer having a carboxyl group, an amino group, or a sulfo group [e.g., a (meta) acrylic acid, methylol (meta) acrylate, hydroxyalkyl (meta) acrylate, aryl acrylate, hydroxyethyl vinylether, hydroxy butylvinylether, maleate, or a crotonic acid]; and a constituent unit formed as a result of introduction of a crosslinking group, such as a (meta) acryloyl group (the crosslinking group can be introduced by causing acrylic chloride act on a hydroxy group).

In addition to fluorine monomer unit and the constituent units for imparting a crosslinking property, a monomer which does not contain fluorine atoms can also be coplymerized, as required, in view of transparency of a coating. No limitations are imposed on monomer units which can be used in combination. Examples of the monomer units include olefines (ethylene, propylene, isoprene, vinyl chloride, and vinylidene chloride, etc.); acrylic esters (methyl acrylate, methyl acrylate, ethyl acrylate, and 2-ethylhexyl acrylate); methacrylate esters (methylmethacrylate, ethyl methacrylate, butyl methacrylate, and ethylene glycol dimethacrylate, etc.); styrene derivatives (styrene, divinylbenzene, vinyltoluene, and α-methylstyrene, etc.); vinyl ethers (methyl vinyl ether, ethyl vinyl ether, and cyclohexyl vinylether, etc.); vinylesters (vinyl acetate, propionate vinyl, and cinnamate vinyl, etc.); acrylamides (N-tert-butyl acrylamide, N-cyclohexyl acrylamide etc.); methacrylamides; and acrylonitrile derivatives or the like.

As described in official gazettes, such as JP-A-10-25388 and JP-A-10-147739, a hardening agent may be used in combination with the above-described polymer.

### (Light Scattering Layer)

The light scattering layer is formed for the purpose of imparting a film with a light scattering property stemming from surface scattering, internal scattering, or a combination thereof, and a hard coating property for enhancing the scratch resistance of a film. Consequently, the light scattering layer is formed by including a binder for imparting a hard coating property, a mat particle for imparting a light scattering property, and, if necessary, an inorganic filler for increasing a refractive index, preventing crosslinking shrinkage, and increasing strength.

With a view toward imparting a hard coating property and maintaining superior processing suitability while retaining brittleness, the thickness of the light scattering layer preferably falls within the range of 1 to 10 μm and more preferably within the range of 1.2 to 6 μm.

The binder of the scattering layer is preferably a polymer having a saturated hydrocarbon chain or a polyether chain as the principal chain, and more preferably a polymer having the saturated hydrocarbon chain as the principal chain. A binder polymer preferably has a crosslink structure. A binder polymer having a saturated hydrocarbon chain as the principal chain is preferably a polymer consisting of ethylene unsaturated monomers. A binder polymer having a saturated hydrocarbon chain as the principal chain and a crosslink structure is preferably a (co)polymer consisting of monomers having two or more ethylene unsaturated groups. In order to render the refractive index of the binder polymer high, there can be selected a monomer containing at least one type of atom, other than a fluorine atom, selected from the group comprising a halogen atom, a sulfur atom, a phosphorous atom, and a nitrogen atom.

A monomer having two or more ethylene unsaturated groups includes an ester of polyhydric alcohol and a (meta) acrylic acid [e.g., ethylene glycol di(meta) acrylate, butanediol (meta) acrylate, hexanediol (meta) acrylate, 1,4-cyclohexane diacrylate, pentaerythritoltetra (meta) acrylate, pentaerythritoltori (meta) acrylate, trimethylolpropanetori (meta) acrylate, trimethylolethanetori (meta) acrylate, dipentaerythritoltetra (meta) acrylate, dipentaerythritolpenta (meta) acrylate, dipentaerythritolhexa (meta) acrylate, pentaerythritolhexa (meta) acrylate, 1,2,3-cyclohexanetetramethacrylate, polyurethane polyacrylate, and polyester polyacrylate], modified ethylene oxide, vinyl benzene, a derivative thereof (e.g., 1,4-divinyl benzene, a 4-vinyl benzoic acid-2-acryloethylester, and 1,4-divinyl hexanone), vinyl sulfon (e.g., divinyl sulfon), acrylic amide (e.g., methylene bisacrylic amide), and methacrylic amide. Two or more types of the above-described monomers may be used in combination.

Specific examples of high refractive monomers include bis(4-methacryloyl thiophenyl) sulfide, vinylnaphthalene, vinylphenyl sulfide, 4-methacryloxyphenyl-4′-methoxyphenylether, or the like. Two or more types of these monomers may also be used in combination.

Polymerization of the monomer having the ethylene unsaturated group can be performed by exposure to ionizing radiation or heating in the presence of an optical radical initiator or a thermal radical initiator.

Accordingly, a coating fluid containing a monomer with an ethylene unsaturated group, an optical radical initiator, a thermal radical initiator, mat particles, and an inorganic filler is prepared. The coating fluid is applied over the transparent support, and the thus-coated support is hardened by means of polymerization reaction stemming from ionizing radiation or heat, to thus form an antireflective film. A known optical radical initiator or the like can be used.

Polymer having polyether as the principal chain is preferably a ring-opening polymer of a multifunctional epoxy compound. A ring-opening polymerization of the multifunctional epoxy compound can be performed by means of irradiation of ionizing radiation or heating in the presence of a photoacid generator or a thermal oxide generator Therefore, a coating fluid containing a monomer with an ethylene unsaturated group, an optical radical initiator, a thermal radical initiator, mat particles, and an inorganic filler is prepared. The coating fluid is applied over the transparent support, and the thus-coated support is hardened by means of polymerization reaction stemming from ionizing radiation or heat, to thus form an antireflective film.

The ionizing radiation is handled herein as being identical with an active energy light source and includes UV radiation, extreme ultraviolet radiation, and X-radiation.

In place of the monomer having two or more ethylene unsaturated groups or in addition thereto, a crosslinking functional group is introduced into a polymer through use of a monomer having the crosslinking functional group. By means of reaction of the crosslinking functional group, the crosslink structure may be introduced into a binder polymer.

Examples of crosslinking functional groups include an isocyanate group, an epoxy group, an aziridine group, an oxazoline group, an aldehyde group, a carbonyl group, a hydrazine group, a carboxyl group, a methylol group, and an active melamine group. Metal alkoxides, such as vinyl sulfone acid, an acid anhydride, a cyanoacrylate derivative, melamine, etherified methylol, ester, urethane, and tetramethoxy silane, can be used as a monomer to introduce the crosslink structure. There may be employed a functional group showing a crosslinking property as a result of decomposition reaction, such as a block isocyanate group. Specifically, in the present invention, it may be the case that the crosslinking functional group does not exhibit a reaction immediately but exhibits reactivity as a result of decomposition.

A crosslink structure can be formed by heating after application of binder polymer having these crosslinking functional groups.

With a view toward imparting an antiglare property, the light scattering layer preferably contains a mat particle having a mean particle size of 1 to 10 μm, more preferably a mean particle size of 1.5 to 7.0 μm; for instance, particles of an inorganic compound or resin particles.

Specific examples of the mat particle include particles of an inorganic compound such as silica particles and TiO₂ particles; and resin particles such as acrylic particles, crosslinked acrylic fibers, polystyrene particles, crosslinked styrene particles, melamine resin particles, and benzoguanamine resin particles. Of these particles, the crosslinked styrene particles, the crosslinked acrylic particles, the crosslinked acrylic styrene particles, and silica particles are preferable. The mat particles can assume either a spherical shape or an amorphous shape.

Moreover, two or more types of mat particles having different particle sizes may be used in combination. The mat particles having a larger particle size can impart an anti-glare property, and the mat particles having a smaller particle size can impart another optical characteristic.

In addition, a mono dispersion is most preferable as the distribution of particle sizes of the mat particles. Preferably, the respective particles are closer to a single size. For instance, when particles larger than 20% a mean particle size are specified as bulky particles, the proportion of the bulky particles is preferably 1% or less of the entire number of particles. More preferably, the proportion is 0.1% or less. Further preferably, the proportion is 0.01% or less. The mat particles having such a distribution of particle sizes are obtained after synthetic reaction. A mat agent having a more preferable distribution can be obtained through classification, by means of increasing the number of classifications or enhancing the degree of classification.

The mat particles are preferably contained in the light scattering layer such that the amount of mat particles in the formed light scattering layer falls within the range of 10 to 1000 mg/m², more preferably within the range of 100 to 700 mg/m².

The distribution of the mat particles is measured by the Coulter Counter method, and the measured distribution is converted into a particle number distribution.

In addition to the mat particle, the light scattering layer contains an oxide of at least one type of metal selected from titanium, zirconium, aluminum, indium, zinc, tin, and atimony, for increasing the refractive index of the light scattering layer. The light scattering layer preferably contains an inorganic filler having a mean particle size of 0.2 μm or less, preferably a mean particle size of 0.1 micrometer or less, and further preferably a mean particle size of 0.06 μm or less.

Conversely, in order to increase a difference between the refractive index of the mat particle and that of the light scattering layer, or in order to maintain low the refractive index of the light scattering layer using high refractive mat particles, use of a silicon oxide is also preferable. A preferable particle size of the silicon oxide is the same as that of the previously-described inorganic filler.

Specific examples of the inorganic filler used for the light scattering layer include TiO₂, ZrO₂, Al₂O₃, In₂O₃, ZnO, SnO₂, Sb₂O₃, ITO, SiO₂, and the like. TiO₂ and ZrO₂ are especially preferable, in view of realization of a high refractive index. The surface of the inorganic filler is also preferably subjected to silane coupling or titanium coupling treatment. A surface treatment agent having a functional group capable of reacting with the binder type provided on the filler is preferably used.

The amount of inorganic fillers to be added is preferably 10 to 90% of the entire weight of the light scattering layer; more preferably 20 to 80%; and particularly preferably 30 to 75%.

Since the particle size of such a filler is sufficiently smaller than the wavelength of light, scattering does not arise. A dispersing element formed as a result of the filler being dispersed in binder polymer behaves as an optically-uniform substance.

The refractive index of a bulk mixture consisting of a binder of the light scattering layer and an inorganic filler preferably falls within the range of 1.48 to 2.00, and more preferably the range of 1.50 to 1.80. In order to bring the refractive index into the foregoing range, the only requirement is to select the type of the binder, the type of the inorganic filler, and a ratio of the binder to the inorganic filler, as required. The manners of selecting the types and ratio can be readily ascertained in advance by experiments.

In order to prevent planar non-uniformity, such as coating unevenness, drying unevenness, and point defects, a coating composition for forming the light scattering layer contains either or both of a fluorine-based surfactant and a silicon-based surfactant. Particularly, an effect for improving planar failures, such as coating unevenness, drying unevenness, or point defects, in the antireflective film of the present invention can be yielded by addition of a smaller amount of the fluorine-based surfactant. This is intended to enhance productivity by imparting high-speed coating ability to the light scattering layer while enhancing the planar uniformity of the light scattering layer.

There will now be described an antireflective film formed by stacking a medium refractive layer, a higher refractive layer, and a lower refractive layer on the transparent protective film, in this sequence.

The antireflective layer formed from a layer structure comprising the medium refractive layer, the higher refractive layer, and the lower refractive layer (the outermost layer) provided in this sequence on the substrate (which is synonymous with a transparent protective film or a transparent support) is designed so as to satisfy the following relationship:

Refractive Index of the Higher Refractive Layer>Refractive Index of the Medium Refractive Layer>Refractive Index of the Transparent Support>Refractive Index of the Lower refractive layer

A hard coating layer may be interposed between the transparent support and the medium refractive layer. Moreover, the antireflective layer may be formed from a medium refractive hard coating layer, a higher refractive layer, and a lower refractive layer.

For instance, antireflective layers described in official gazettes, such as JP-A-8-122504, JP-A-8-110401, JP-A-10-300902, JP-A-2002-243906, and JP-A-2000-111706, can be provided. Alternatively, another function may be imparted to the respective layers. For instance, a lower refractive layer exhibiting a stain-proof property and a higher refractive layer exhibiting an antistatic property (see, e.g., JP-A-10-206603, JP-A-2002-243906, or the like) can be provided.

The haze of the antireflective layer is preferably 5% or less, more preferably 3% or less. Further, the strength of the film is preferably H or more as determined by the pencil hardness test complying with JIS K5400, more preferably 2 H or more, and most preferably 3 H or more.

### (Higher Refractive Layer and Medium Refractive Layer)

The higher refractive layer of the antireflective layer is formed from a hard film which has a mean particle size of 100 nm or less and contains at least inorganic ultrafine particles and a matrix binder.

An inorganic compound having a refractive index of 1.65 or more is provided as the inorganic compound fine particulate having a high refractive index. An inorganic compound having a refractive index of 1.9 or more is preferable. For instance, oxides of Ti, Zn, Sb, Sn, Zr, Ce, Ta, La, and In and composite oxides containing these metal atoms are provided.

Such ultrafine particles are embodied by subjecting the surfaces of particles to treatment with a surface treatment agent (e.g., a silane coupling agent described in JP-A-11-295503, JP-A-11-153703, and JP-A-2000-9908, or an anionic compound or an organic metal coupling agent described in JP-A-2001-310432), formation of a core shell structure having highly-refractive particles as a core (JP-A-2001-166104), and combined usage of specific dispersing agents (described in, e.g., JP-A-11-153703, U.S. Pat. No. 6,210,858B1, and JP-A-2002-2776069).

A well-known thermoplastic resin, a thermosetting film, or the like, is provided as material to be used for forming a matrix.

In addition, at least one type of composition—selected from the group consisting of a polyfunctional-compound-containing composition containing at least two pieces or more of a radical polymerized group and/or a cationic polymerized group, an organic metal compound containing a hydrolysis group, and a partially-condensed compound thereof—is preferable. For instance, compounds described in JP-A-2000-47004, JP-A-2001-315242, JP-A-2001-31871, and JP-A-2001-296401 are provided.

A hardened film formed from a colloidal metal oxide or a metal alkoxide composition which are obtained from a hydrolytically-condensed produce of metal alkoxide is also preferable. This is described in, e.g., JP-A-2001-293818.

A refractive index of the higher refractive layer usually falls within the range of 1.70 to 2.20. The thickness of the higher refractive layer preferably falls within the range of 5 nm to 10 μm, more preferably 10 μm to 1 micrometer.

The refractive index of the medium refractive layer is controlled so as to assume a value between the refractive index of the lower refractive layer and the refractive index of the higher refractive layer. The refractive index of the medium refractive layer preferably falls within the range of 1.50 to 1.70. The thickness of the medium refractive layer preferably falls within the range of 5 nm to 10 μm, more preferably 10 μm to 1 micrometer.

### (Lower Refractive Layer)

The lower refractive layer is sequentially stacked on the higher refractive layer. The refractive index of the lower refractive layer falls within the range of 1.20 to 1.55, preferably the range of 1.30 to 1.50.

The lower refractive layer is preferably formed as an outermost layer exhibiting scratch resistance and a stain-proof property. Imparting a slippage property to a surface is effective as means for greatly enhancing the scratch resistance. A thin film formed by introduction of conventionally-known silicon or fluorine can be applied as means of imparting a slippage property.

The refractive index of the fluorine compound preferably falls within the range of 1.35 to 1.50, more preferably 1.36 to 1.47. A compound containing a crosslinked or polymerized functional group containing 35 to 80% weight percent of fluorine atoms is preferable as the fluorine compound.

For instance, compounds described in paragraph numbers (0018) to (0026) of JP-A-9-222503, paragraph numbers (0019) to (0030) of JP-A-11-38202, paragraph numbers (0027) to (0028) of JP-A-2001-40284, and JP-A-2000-284102 are provided.

A compound having a polysiloxane structure, where a polymer chain contains a curable functional group or a polymeric functional group and a crosslink structure formed in a film, is preferable as the silicon compound. For instance, reactive silicon [e.g., Silaplane (manufactured by CHISSO Corporation) and polysiloxane containing a silanol group at both ends (JP-A-11-258403)] or the like is provided.

Crosslinking or polymerizing reaction of fluorine polymer and siloxane polymer, which have a crosslink or a polymeric group, is preferably performed simultaneously with application of a coating composition containing a polymerization initiator, a sensitizer, or the like, or after application of the coating composition through exposure or heating.

Moreover, a sol gel hardening film-which hardens an organic metal compound, such as a silane coupling agent, and a silane coupling agent containing a specific fluorine-containing hydrocarbon group in the presence of a catalyst-is also preferable.

For instance, a polyfluoroalkyl-group-containing silicon compound or a partially-hydrolytically-condensed product thereof (compounds described in official gazettes, e.g., JP-A-58-142958, JP-A-58-147483, JP-A-58-147484, JP-A-9-157582, and JP-A-11-106704), a silyl compound containing poly(perfluoroalkyl ether)—which is a long chain radical containing fluorine—(compounds described in official gazettes, e.g., JP-A-2000-117902, JP-A-2001-48590, and JP-A-2002-53804), or the like are provided.

The lower refractive layer contains, as an additive in addition to those mentioned above, a filler [e.g., a low refractive inorganic compound having an average primary particle size of 1 to 150 nm, such as silicon dioxide (silica), fluorine particles (magnesium fluoride, calcium fluoride, and barium fluoride), organic particles described in paragraph numbers (0020) to (0038) of JP-A-11-3820, or the like], a silane coupling agent, a slip additive, a surfactant, or the like.

When the lower refractive layer is situated at a position below the outermost layer, the lower refractive layer may be formed by a gaseous phase process (a vacuum deposition process, a sputtering process, ion plating processing, a plasma CVD process, or the like). In view of the ability to manufacture the lower refractive layer at low cost, the coating method is preferable.

The thickness of the lower refractive layer preferably falls within the range of 30 to 200 nm, more preferably within the range of 50 to 150 nm, and most preferably within the range of 60 to 120 nm.

### (Other Layers of the Antireflective Layer)

A hard coating layer, a forward scattering layer (an antiglare layer), a primer layer, an antistatic layer, an undercoating layer, a protective layer, or other layers may be additionally provided.

### (Hard Coating Layer)

The hard coating layer is provided on the surface of the transparent support for imparting physical strength to the transparent protective film provided with the antireflective layer. Particularly, the hard coating layer is preferably interposed between the transparent support and the higher refractive layer. The hard coating layer is preferably formed by a crosslinking reaction between photocuring and/or thermosetting compounds or by polymerization. A photopolymeric functional group is preferable as the curable functional group, and an organic alkoxysilyl compound is preferable as the organometallic compound containing a hydrolytic functional group.

Specific examples of these compounds are the same as those specified in connection with the higher refractive layer. Compositions described in, e.g., JP-A-2002-144913, JP-A-2000-9908, and WO00/46617, are provided as a specific constitutional composition of the hard coating layer.

The higher refractive layer can double as the hard coating layer. In such a case, fine particles are minutely dispersed through use of the process described in connection with the higher refractive layer, and the hard coating layer can be formed by containing the thus-disposed fine particles.

The hard coating layer can also double as an antiglare layer imparted with an antiglare function as a result of containing particles having a mean particle size ranging from 0.2 to 10 μm.

The thickness of the hard coating layer can be designed appropriately according to an application. The thickness of the hard coating layer preferably falls within the range of 0.2 to 10 μm, more preferably 0.5 to 7 μm.

The strength of the hard coating layer is preferably H or more as determined by the pencil hardness test complying with JIS K5400, more preferably 2 H or more, and most preferably 3 H or more. Moreover, a smaller amount of a test piece abraded after a tapering test complying with JIS K5400 is preferable.

### (Antistatic Layer)

When the antistatic layer is provided, imparting of conductivity having a volume resistivity of 10⁻⁸(Ω cm⁻³) or less is preferable. Imparting of conductivity having a volume resistivity of 10⁻⁸(Ω cm⁻³) is possible through use of a hygroscopic material, a water-soluble inorganic salt, a certain type of surfactant, cationic polymer, anionic polymer, colloidal silica, or the like. Therefore, a metal oxide is preferable as material of the conductive layer. Some of the metal oxides are colored. However, when the metal oxide is used as a conductive layer material, the entire film is colored. Thus, the colored metal oxide is not preferable. Zn, Ti, Al, In, Si, Mg, Ba, Mo, W, or V can be provided as metal which forms an uncolored metal oxide. Use of a metal oxide containing any of these metals as the principal ingredient is preferable. Preferred examples are ZnO, TiO₂, SnO₂, Al₂O₃, In₂O₃, SiO₂, MgO, BaO, MoO₃, V₂O₅, or composite oxides thereof. Especially, ZnO, TiO₂, SnO₂ are preferable. In relation to examples of metal oxides containing a different type of atom, addition of Al, In, or the like, to ZnO; addition of Sb, Nb, or a halogen atom to SnO₂; and addition of Nb, TA, or the like, to TiO₂ are effective. Moreover, as described in JP-B-59-6235, there may also be employed a raw material formed by causing any of the above metal oxides to adhere to other crystalline metal particles or fibrous substances (e.g., titanium oxides). The volume resistivity value and the surface resistance value are different material values and simple comparison thereof is impossible. In order to ensure conductivity equal to a volume resistivity of 10⁻⁸(Ω cm⁻³) or less, the only requirement for the conductive layer is to possess surface resistance of about 10⁻¹⁰(Ω/□) or less, more preferably, 10⁻⁸(Ω/□) or less. The surface resistance value of the conductive layer is measured as a value to be obtained when the antistatic layer is taken as the outermost layer, and the surface resistance value can be measured at any point until a stage for forming the multilayer film described herein.

### (Liquid Crystal Display)

The polarizing plate using the cellulose acylate film of the present invention is advantageously used in a liquid crystal display. The polarizing plate of the present invention can be used in the liquid crystal cell of any of various display modes. Various display modes have been proposed, such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), and HAN (Hybrid Aligned Nematic). Of these modes, the OCB mode or the VA mode is preferably used.

The liquid crystal cell of OCB mode is a liquid crystal display using a liquid crystal cell of bend orientation mode, wherein rod-shaped liquid crystal molecules have substantially opposite orientations (are substantially symmetrical) between upper and lower portions of the liquid crystal cell. Since the rod-shaped liquid crystal molecules are oriented symmetrically between upper and lower portions of the liquid crystal cell, the liquid crystal cell of bend orientation mode has a self optical compensation function. Therefore, this liquid crystal mode is also called an OCB (Optically Compensatory Bend) liquid crystal mode. The liquid crystal display of bend orientation mode has a merit of a high response speed.

When no voltage is applied to the liquid crystal cell of VA mode, the rod-shaped liquid crystal molecules are oriented substantially vertically.

In addition to including (1) a liquid crystal cell of VA mode in a narrow sense where rod-shaped liquid crystal molecules are oriented substantially vertically when no voltage is applied and the rod-shaped liquid crystal molecules are oriented substantially horizontally when a voltage is applied (as described in JP-A-2-176625), the liquid crystal cell of VA mode encompasses (2) a liquid crystal cell having a multi-domain VA mode (MVA mode) for enlarging a view angle [as described in SID97, Digest of Tech. Papers (Proceeding) 28 (1997) pg. 845], (3) a liquid crystal cell of a mode (n-ASM mode) where the rod-shaped liquid crystal molecules are oriented substantially vertically when no voltage is applied and the molecules are oriented in the form of a twisted multi-domain when a voltage is applied [as described in the proceeding of the Japanese liquid crystal symposium pp. 58 to 59 (1998)], and (4) a liquid crystal cell of SURVIVAL mode (as presented in LCD International 98).

In the liquid crystal displays of OCB mode and VA mode, a liquid crystal cell may be interposed between two polarizing plates. In the case of the liquid crystal display of VA mode, the polarizing plate may be disposed on the backlight side of the liquid crystal cell. The liquid crystal cell holds liquid crystal between two electrode substrates.

### EXAMPLES

The present invention will be described specifically hereinbelow by reference to examples. However, the present invention is not limited to the examples.

### Example 1

### (Preparation of Cellulose Acylate Film 1)

Respective compositions of the cellulose acetate solution provided below were charged into a mixing tank and stirred and dissolved while being heated, to thus prepare the cellulose acetate solution.

### (Composition of the Cellulose Acetate Solution)

| | |
|---|---|
| Cellulose acetate | 100 parts by weight |
| (acetyl substitution degree of 2.87, and total | |
| substitution degree of 2.87) | |
| Triphenyl phosphate (plasticizer) | 7.8 parts by weight |
| Biphenyl diphenyl phosphate (plasticizer) | 3.9 parts by weight |
| Methylene chloride (a first solvent) | 318 parts by weight |
| Methanol (a second solvent) | 47 parts by weight |
| Silica (having a particle size of 0.2 μm) | 0.1 parts by weight |

Twenty parts by weight of the retardation-developing agent provided below, 87 parts by weight of methylene chloride, and 13 parts by weight of methanol were charged into another mixing tank and stirred while being heated, to thus prepare a retardation-developing agent solution 01.

A total of 23.5 parts by weight of the retardation-developing (controlling or increasing) agent 01 were mixed with 474 parts by weight of the cellulose acetate solution and the resultant solution was sufficiently stirred, to thus prepare a dope. The amount of retardation-developing agent added was 3.9 parts by weight with respect to 100 parts by weight of cellulose acetate.

Retardation-developing Agent

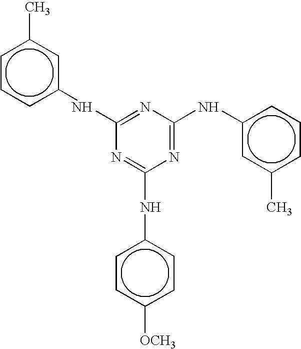

The thus-obtained dope was flow-cast through use of a band casting machine. A film having 25 parts by weight of residual solvent was laterally cast at a casting scale of 26% at 130° C. through use of a tenter, to thus prepare a cellulose acetate film (having a thickness of 91 μm). The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 2

### (Preparation of Cellulose Acylate Film 2)

A total of 17.5 parts by weight of the retardation-developing agent solution 01 were mixed into 474 parts by weight of the cellulose acetate solution prepared in Example 1, and the mixture was stirred to thus prepare a dope. The amount of retardation-developing agent added was 2.9 parts by weight with respect to 100 part by weight of cellulose acetate.

A cellulose acetate film (having a thickness of 92 μm) was prepared in the same manner as in Example 1, except that the flow-cast temperature was set to 135° C. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 3

### (Preparation of Cellulose Acylate Film 3)

16 parts by weight of the retardation-developing agent provided below, 87 parts by weight of methylene chloride, and 13 parts by weight of methanol were charged into another mixing tank and stirred while being heated, to thus prepare a retardation-developing agent solution 02.

Twenty-five parts by weight of the retardation-developing agent 02 were mixed into 474 parts by weight of the cellulose acetate solution of Example 1 and the resultant solution was sufficiently stirred, to thus prepare a dope. The amount of retardation-developing agent added was 4.2 parts by weight with respect to 100 parts by weight of cellulose acetate.

Retardation-developing Agent

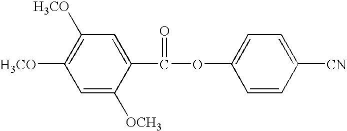

After having been flow-cast on the band, the dope was exfoliated at 32% of residual solvent. The thus-removed dope was laterally drawn by a tenter drawing machine. The flow-cast scale was set to 30%, and the flow-cast temperature was set to 110C. Subsequently, the thus-cast dope was dried in hot air of 130° C. to thus prepare cellulose acetate film. The dried film had a thickness of 96 μm. As in the case of Example 1, the Re retardation value and the Rth retardation value of the thus-prepared cellulose acetate film were evaluated. Results of measurement are provided in Table 1.

### Example 4

### (Preparation of Cellulose Acylate Film 4)

16 parts by weight of the retardation-developing agent provided below, 87 parts by weight of methylene chloride, and 13 parts by weight of methanol were charged into another mixing tank and the resultant solution was stirred while being heated, to thus prepare a retardation-developing agent solution 03.

Thirty parts by weight of the retardation-developing agent were mixed into 474 parts by weight of the cellulose acetate solution of Example 2 and the resultant solution was sufficiently stirred, to thus prepare a dope. The amount of retardation-developing agent added was 5.0 parts by weight with respect to 100 parts by weight of cellulose acetate.

Retardation-developing Agent

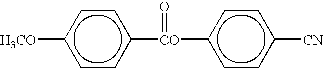

A cellulose acetate film was prepared in the same manner as in Example 1, except that the flow-cast scale was set to 28% and the thickness of the film was set to 82 μm. The Re retardation value and the Rth retardation value of the thus-prepared cellulose acetate film were measured, as in the case of Example 1. Results of measurement are provided in Table 1.

### Example 5

### (Preparation of Cellulose Acylate Film 5)

Respective compositions of the cellulose acetate solution provided below were charged into a mixing tank and stirred and dissolved while being heated, to thus prepare the cellulose acetate solution.

### (Composition of the Cellulose Acetate Propionate Solution)

| | |
|---|---|
| Cellulose acetate propionate | 100 parts by weight |
| (CAP-482-20 Eastman Chemical Ltd.) | |
| Triphenyl phosphate (plasticizer) | 3.9 parts by weight |
| Biphenyl diphenyl phosphate (plasticizer) | 1.9 parts by weight |
| Methylene chloride (the first solvent) | 317 parts by weight |
| Methanol (the second solvent) | 28 parts by weight |
| Silica (having a particle size of 0.2 μm) | 0.1 parts by weight |

Thirty-six parts by weight of the retardation-developing agent 01 were mixed into 450 parts by weight of the cellulose acetate propionate solution and the resultant solution was sufficiently stirred, to thus prepare a dope. The amount of retardation-developing agent added was 6.0 parts by weight with respect to 100 parts by weight of cellulose acetate propionate.

A cellulose acetate propionate film laterally flow-cast as in the case of Example 1 was prepared, except that the flow-cast scale was set to 30%. The Re retardation value and the Rth retardation value of the thus-prepared cellulose acetate propionate film were measured at a wavelength of 590 nm through use of KOBRA (21 ADH manufactured by Oji Scientific Instruments Ltd.). Results of measurement are provided in Table 1.

### Example 6

### (Preparation of Cellulose Acylate Film 6)

Respective compositions of the cellulose acetate butyrate solution provided below were charged into a mixing tank and stirred and dissolved while being heated, to thus prepare the cellulose acetate solution. (Composition of the Cellulose Acetate Butyrate Solution)

| | | |
|---|---|---|
| Cellulose acetate butyrate | 100 | parts by weight |
| (CAB-381-20 Eastman Chemical Ltd.) | | |
| Triphenyl phosphate (plasticizer) | 2.0 | parts by weight |
| Biphenyl diphenyl phosphate (plasticizer) | 1.0 | part by weight |
| Methylene chloride (the first solvent) | 309 | parts by weight |
| Methanol (the second solvent) | 27 | parts by weight |
| Silica (having a particle size of 0.2 μm) | 0.1 | parts by weight |

Eighteen parts by weight of the retardation-developing agent 01 were mixed into 438 parts by weight of the cellulose acetate butyrate solution and the resultant solution was sufficiently stirred, to thus prepare a dope. The amount of retardation-developing agent added was 3.2 parts by weight with respect to 100 parts by weight of cellulose acetate butyrate.

A cellulose acetate butyrate film was prepared by subjecting the dope to flow-cast processing as in the case of Example 5. The Re retardation value and the Rth retardation value of the thus-prepared cellulose acetate butyrate film were measured at a wavelength of 590 nm through use of KOBRA (21 ADH manufactured by Oji Scientific Instruments Ltd.). Results of measurement are provided in Table 1.

### Example 7

### (Preparation of Cellulose Acylate Film 7)

Sixteen parts by weight of the retardation-developing agent analogous to that used in Example 5, 1.2 parts by weight of an ultraviolet absorber B (TINUVIN 327 manufactured by Ciba Specialty Chemicals Ltd.), 2.4 parts by weight of an ultraviolet absorber C (TINUVIN 328 manufactured by Ciba Specialty Chemicals Ltd.), 87 parts of methylene chloride, and 13 parts by weight of methanol were charged into the mixing tank and the resultant solution was stirred while being heated, to thus prepare the retardation-developing agent solution.

Thirty-six parts by weight of the retardation-developing agent were mixed into 474 parts by weight of the cellulose acetate solution of Example 2 and the resultant solution was sufficiently stirred, to thus prepare a dope. The amount of retardation-developing agent added was 5.0 parts by weight with respect to 100 parts by weight of cellulose acetate.

A cellulose acetate film was prepared as in the case of Example 1. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 8

### (Preparation of Cellulose Acylate Film 8)

Respective compositions of the cellulose acetate solution provided below were charged into a mixing tank and stirred and dissolved while being heated, to thus prepare the cellulose acetate solution.

### (Composition of the Cellulose Acetate Solution)

| | | |
|---|---|---|
| Cellulose acetate | 100 | parts by weight |
| (an acetyl substitution degree of 2.80, and a | | |
| substitution degree of 91% at sixth position) | | |
| Triphenyl phosphate (plasticizer) | 7.8 | parts by weight |
| Biphenyl diphenyl phosphate (plasticizer) | 3.9 | part by weight |
| Methylene chloride (the first solvent) | 318 | parts by weight |
| Methanol (the second solvent) | 47 | parts by weight |
| Silica (having a particle size of 0.2 μm) | 0.1 | parts by weight |

33 parts by weight of the retardation-developing agent 01 were mixed into 474 parts by weight of the cellulose acetate solution and the resultant solution was sufficiently stirred, to thus prepare a dope. The amount of retardation-developing agent added was 5.5 parts by weight with respect to 100 parts by weight of cellulose acetate butyrate.

A cellulose acetate film was prepared as in the case of Example 1. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 9

### (Preparation of Cellulose Acylate Film 9)

Respective compositions of the cellulose ester solution provided below were charged into a mixing tank and stirred and dissolved while being heated, to thus prepare the cellulose acetate solution.

### (Composition of the Cellulose Acetate Solution)

| | |
|---|---|
| Cellulose acetate propionate | 100 parts by mass |
| (an acetyl substitution degree of 1.90, and a | |
| propionyl substitution degree of 0.80) | |
| Triphenyl phosphate (plasticizer) | 8.5 parts by mass |
| Ethylphthalylethylglycolate | 2.0 parts by mass |
| Methylenechloride | 290 parts by mass |
| Ethanol | 60 parts by mass |

Five parts by weight of cellulose acetate propionate, 6 parts by weight of Tinuvin 326 (Ciba Specialty Chemicals Ltd.), 4 parts by weight of Tinuvin 109 (Ciba Specialty Chemicals Ltd.), and 5 parts by weight of Tinuvin 171 (Ciba Specialty Chemicals Ltd.) were charged into another mixing tank and stirred while being heated along with introduction of 94 parts by weight of methylene chloride and 8 parts b weight of ethanol, to thus prepare a solution to be added.

Ten parts by weight of the solution were mixed into 474 parts by weight of cellulose acetate solution and the resultant solution was sufficiently stirred, to thus prepare a dope.

A cellulose acetate film 9 laterally flow-cast as in the case of Example 1 was prepared, except that the flow-cast scale was set to 30% and the thickness of the film was set to 80 μm. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 10

Respective compositions of the cellulose ester solution provided below were charged into a mixing tank and stirred and dissolved while being heated, to thus prepare the cellulose acetate solution.

### (Composition of the Cellulose Acetate Solution)

| | | |
|---|---|---|
| Cellulose acetate | 100 | parts by weight |
| (an acetyl substitution degree of 2.80, and a | | |
| substitution degree of 91% at sixth position) | | |
| Triphenyl phosphate (plasticizer) | 7.8 | parts by weight |
| Biphenyl diphenyl phosphate (plasticizer) | 3.9 | parts by weight |
| Methylene chloride (the first solvent) | 318 | part by weight |
| Retardation-developing agent described in | 5.1 | parts by weight |
| Example | | |
| Methanol (the second solvent) | 47 | parts by weight |
| Silica (having a particle size of 0.2 μm) | 0.1 | parts by weight |

A cellulose acetate film laterally flow-cast as in the case of Example 1 was prepared, except that the flow-cast scale was set to 28% and the thickness of the film was set to 95 μm. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### Example 11

Respective compositions of the cellulose ester solution provided below were charged into a mixing tank and stirred and dissolved while being heated, to thus prepare the cellulose acetate solution.

### (Composition of the Cellulose Acetate Solution)

| | | |
|---|---|---|
| Cellulose acetate | 100 | parts by weight |
| (an acetyl substitution degree of 2.80, and a | | |
| substitution degree of 91% at sixth position) | | |
| Triphenyl phosphate (plasticizer) | 7.8 | parts by weight |
| Biphenyl diphenyl phosphate (plasticizer) | 3.9 | parts by weight |
| Methylene chloride (the first solvent) | 318 | part by weight |
| Retardation-developing agent described in | 5.0 | parts by weight |
| Example | | |
| Methanol (the second solvent) | 47 | parts by weight |
| Silica (having a particle size of 0.2 μm) | 0.1 | parts by weight |

A cellulose acetate film laterally flow-cast as in the case of Example 1 was prepared except that the flow-cast scale was set to 30% and the thickness of the film was set to 95 μm. The Re retardation value and the Rth retardation value of the thus-prepared cellulose acetate film were measured at a wavelength of 590 nm through use of KOBRA (21 ADH manufactured by Oji Scientific Instruments Ltd.). Results of measurement are provided in Table 1.

### (Measurement of Photoelastic Coefficient)

The photoelastic coefficient was measured through use of AEP-100 (manufactured by Shimadzu Corporation) while the film was fixed and a custom-designed jig to be used for exerting load was attached to the film. A distance between the point where the sample was supported and the load was set to 10 cm. Loads of 270 g, 800 g, 1300 g, 1800 g, and 2300 g were used. Retardation of the film was measured in a normal direction on the film surface while the load was exerted on the film, to thus determine a photoelastic coefficient.

TABLE 1

| | Film | | | Photoelastic | | | | | Water-Vapor |
|---|---|---|---|---|---|---|---|---|---|
| | Thickness | Re(590) | Rth(590) | Coefficient | Haze | Tg | Elasticity | Equilibrium Moisture Content | Permeability |
| | (μm) | (nm) | (nm) | (cm²/dyne) | (%) | (° C.) | (Gpa) | (at 25° C. and 80% RH) | (g/m² · 24 hr) |
| Example 1 | 91 | 32 | 158 | 11 × 10⁻¹³ | 0.6 | 131 | 4.50 | 3.1 | 430 |
| Example 2 | 92 | 30 | 130 | 11 × 10⁻¹³ | 0.6 | 133 | 4.65 | 3.2 | 435 |
| Example 3 | 96 | 39 | 142 | 11 × 10⁻¹³ | 0.8 | 132 | 4.55 | 3.1 | 430 |
| Example 4 | 82 | 52 | 135 | 11 × 10⁻¹³ | 0.9 | 133 | 4.61 | 3.1 | 430 |
| Example 5 | 93 | 70 | 279 | 12 × 10⁻¹³ | 0.7 | 120 | 2.05 | 1.8 | 730 |
| Example 6 | 92 | 70 | 278 | 13 × 10⁻¹³ | 0.7 | 105 | 1.70 | 1.5 | 590 |
| Example 7 | 91 | 33 | 163 | 11 × 10⁻¹³ | 0.7 | 131 | 4.52 | 3.0 | 427 |
| Example 8 | 108 | 65 | 240 | 12 × 10⁻¹³ | 0.8 | 128 | 4.48 | 3.0 | 420 |
| Example 9 | 80 | 38 | 129 | 13 × 10⁻¹³ | 0.7 | 135 | 2.70 | 3.2 | 615 |
| Example 10 | 95 | 70 | 220 | 12 × 10⁻¹³ | 0.8 | 130 | 4.45 | 3.0 | 430 |
| Example 11 | 95 | 70 | 210 | 12 × 10⁻¹³ | 0.8 | 132 | 4.60 | 3.1 | 437 |

### Example 12

### (Manufacture of Polarizing Plates 1 to 11)

A polarizing film was made by causing iodine to adhere to the flow-cast polyvinyl alcohol film.

The thus-formed cellulose acylate film 1 was saponified, and the film was affixed to one side of the polarizing film. Saponification was conducted under the following conditions.

A total of 1.5N of a sodium hydroxide solution was prepared and maintained at 55° C. Meanwhile, 0.01N of a diluted sulfuric acid solution was prepared and maintained at 35° C. The thus-prepared cellulose acetate film was immersed in a sodium hydroxide solution for two minutes. The film was then immersed in water, thereby sufficiently washing away the sodium hydroxide solution. Next, the film was immersed in the diluted sulfuric acid solution for one minute and then immersed in water, thereby sufficiently washing away the diluted sulfuric acid solution. Finally, the sample was sufficiently dried at 120° C.

Similarly, a commercially-available cellulose triacetate film (Fuji-tack TD80UF, Fuji Photo Film Co., Ltd.) was saponified in a similar manner. The film was then affixed to the side of the polarizing film opposite the side affixed with the cellulose acetate film, through use of a polyvinyl-alcohol-based adhesive.

The transmission axis of the polarizing film was arranged in parallel with the lagging axis of the prepared cellulose acetate film. The transmission axis of the polarizing film was arranged so as to cross at right angles the lagging axis of the commercially-available cellulose acetate film.

Thus, a polarizing plate 1 was manufactured. Similarly, polarizing plates 2 to 11 using cellulose acylate films 2 to 11 were manufactured.

### Example 13

### (Manufacture of Polarizing Plate 12)

A polarizing plate 12 was manufactured in the same manner as in Example 12, except that a commercially-available cellulose acetate film (Fuji-tuck TD80UF, Fuji Photo Film Co., Ltd.) was used in place of the cellulose acylate films prepared in Examples 1 through 11.

### Example 14

### (Manufacture of a Liquid Crystal Display and Evaluation Thereof)

One part by weight of octadecyl dimethylammonium chloride (a coupling agent) was added to 3 parts by weight of polyvinyl alcohol solution. The mixture was spin-coated over a glass substrate in the vicinity of an ITO electrode and was subjected heat treatment at 160° C. Subsequently, the substrate was subjected to rubbing, thereby forming a vertically-oriented film. The rubbing was performed such that rubbing directions of two glass substrate become opposite to each other. The two glass substrates were arranged so as to face each other with a cell gap (d) of 5 μm. A liquid crystal compound (Δn: 0.08) containing ester and ethane as the principal ingredients was poured into the cell gap, to thus fabricate a vertically-oriented crystal cell. A product of Δn and “d” was 400 nm.

After the humidity of the thus-manufactured polarizing plate 1 has been controlled beforehand under the temperature and humidity conditions provided in Table 2, the plate was housed in the moisture-proofed container for three days. The container is a packing material comprising a laminate structure consisting of polyethylene terephthalate/aluminum/polyethylene. The water-vapor permeability was 1×10⁻⁵ g/m²·Day or less.

The polarizing plate 1 was removed from the container under the environment described in Table 2, and was affixed to both sides of the thus-manufactured vertically-oriented liquid crystal cell with an adhesive sheet, to thus manufacture a liquid crystal display.

The color of a black display was measured through use of a measuring instrument (EZ-Contrast 160D, ELDIM Company) at an azimuth angle of 45° with respect to the lateral direction on the thus-manufactured liquid crystal display screen and at a polar angle of 60° with respect to the direction perpendicular to the screen surface. The thus-measured colors were taken as initial values. This panel was then left for a week in a chamber of room temperature and humidity (at about 25° C. without humidity control). The color of the black display was measured again.

The polarizing plate used in a commercial product (a 17-inch panel manufactured by Fujitsu Ltd.) was removed, and the thus-removed polarizing plate was subjected to similar treatment and measurement. The amount of change in black color acquired in the polarizing plate 1 and the amount of change in black color acquired in the commercial polarizing plate were compared with each other. The amounts of changes were substantially the same.

### Example 15

### (Manufacture of a Liquid Crystal Display and Evaluation Thereof)

The vertically-oriented liquid crystal cell was manufactured in the same manner as in Example 14, except that the cell gap (d) was set to 3.5 μm. The product of Δn and “d” was 350 nm. Both sides of the liquid crystal cell were subjected to treatment in the same manner as in Example 14, and then the polarizing plate 2 was affixed to both sides of the cell to thus manufacture a liquid crystal display. Changes in the color of the black display of the thus-manufactured liquid crystal display were measured in the same manner as in Example 14. Differences between the initial values and the measured values were determined. As a result, changes in all of the polarizing plates were found to be small and substantially the same as those in the polarizing plate used in the commercially-available product.

### Example 16

### (Manufacture of a Liquid Crystal Display and Evaluation Thereof)

The vertically-oriented liquid crystal cell was manufactured in the same manner as in Example 14, except that the cell gap (d) was set to 4.7 μm. The product of Δn and “d” was 376 nm. Both sides of the liquid crystal cell were subjected to treatment in the same manner as in Example 14, and then the polarizing plate 13 was affixed to both sides of the cell to thus manufacture a liquid crystal display.

Changes in the color of the black display of the thus-manufacture liquid crystal display were measured in the same manner as in Example 14. Differences between the initial values and the measured values were determined. Changes in all of the polarizing plates were small and substantially the same as those in the polarizing plate used in the commercially-available product.

### Example 17

### (Manufacture of a Liquid Crystal Display and Evaluation Thereof)

One part by weight of octadecyl dimethylammonium chloride (a coupling agent) was added to 3 parts by weight of polyvinyl alcohol solution. The mixture was spin-coated over a glass substrate in the vicinity of an ITO electrode and was subjected heat treatment at 160° C. Subsequently, the substrate was subjected to rubbing, thereby forming a vertically-oriented film. The rubbing was performed such that rubbing directions of two glass substrates become opposite to each other. The two glass substrates were arranged so as to face each other with a cell gap (d) of 4.5 μm. A liquid crystal compound (Δn: 0.082) containing ester and ethane as the principal ingredients was poured into the cell gap, to thus fabricate a vertically-oriented crystal cell. A product of Δn and “d” was 369 nm. Both sides of the liquid crystal cell were subjected to treatment in the same manner as in Example 14, and then the polarizing plate 4 was affixed to both sides of the cell to thus manufacture a liquid crystal display.

Changes in the color of the black display of the thus-manufacture liquid crystal display were measured in the same manner as in Example 14. Differences between the initial values and the measured values were determined. As a result, changes in all of the polarizing plates were small and substantially the same as those in the polarizing plate used in the commercially-available product.

### Example 18

### (Manufacture of a Liquid Crystal Display and Evaluation Thereof

The thus-manufactured polarizing plates 5, 6, and 12 were housed under the temperature and humidity conditions described in Table 2 in the same manner as in Example 14 and left for three days.

The polarizing plate 5 taken out of the container was affixed to one side of the liquid crystal cell used in Example 14, through use of an adhesive sheet. The polarizing plate 12 was similarly affixed to the other side of the liquid crystal cell.

Similarly, a combination of the polarizing plates 6 and 12 were affixed to the liquid crystal cell.

The color of a black display was measured through use of a measuring instrument (EZ-Contrast 160D, ELDIM Company) at an azimuth angle of 45° with respect to the lateral direction on the thus-manufactured liquid crystal display screen and at a polar angle of 60° with respect to the direction normal to the screen surface. The thus-measured colors were taken as initial values. These panels were then left for one week in the chamber of room temperature and humidity (at about 25° C. without humidity control). The color of the black display was again measured. Differences between the initial values and the measured values were determined. As a result, changes in all of the polarizing plates were found to be small, and were smaller than those in the polarizing plate used in the commercially-available product.

### Example 19

### (Manufacture of a Liquid Crystal Display and Evaluation Thereof)

Both sides of the liquid crystal cell were subjected to treatment in the same manner as in Example 14, and then the polarizing plate 7 was affixed to both sides of the liquid crystal cell manufactured in Example 14, to thus manufacture a liquid crystal display. Changes in the color of the black display of the thus-manufactured liquid crystal display were measured in the same manner as in Example 14. Differences between the initial values and the measured values were determined. As a result, changes in all of the polarizing plates were found to be small and substantially the same as those in the polarizing plate used in the commercially-available product.

### Example 20

### (Manufacture of a Liquid Crystal Display and Evaluation Thereof)

The thus-manufactured polarizing plates 8 and 12 were housed under the temperature and humidity conditions described in Table 2 in the same manner as in Example 14 and left for three days.

As in the case of Example 18, the polarizing plates 8, 12 were affixed to both sides of the liquid crystal cell manufactured in Example 15. Changes in the color of the black display were measured in the same manner as in Example 18. Changes were small and substantially the same as those in the polarizing plate used in the commercially-available product.

### Example 21

### (Manufacture of a Liquid Crystal Display and Evaluation Thereof)

The thus-manufactured polarizing plates 9 and 12 were housed under the temperature and humidity conditions described in Table 2 in the same manner as in Example 14 and left for three days.

The polarizing plates 9, 12 were affixed to both sides of the liquid crystal cell manufactured in Example 15, as in the case of Example 18. Changes in the color of the black display were measured in the same manner as in Example 18. Changes were small and substantially the same as those in the polarizing plate used in the commercially-available product.

### Example 22

The thus-manufactured polarizing plates 10 and 12 were packed under the temperature and humidity conditions described in Table 2 in the same manner as in Example 14 and left for three days.

The polarizing plates 10, 12 were affixed to both sides of the liquid crystal cell manufactured in Example 15, as in the case of Example 18. Changes in the color of the black display were measured in the same manner as in Example 18. Changes were small and substantially the same as those in the polarizing plate used in the commercially-available product.

### Example 23

The thus-manufactured polarizing plates 11 and 12 were packed under the temperature and humidity conditions described in Table 2 in the same manner as in Example 14 and left for three days.

The polarizing plates 11, 12 were affixed to both sides of the liquid crystal cell manufactured in Example 15, as in the case of Example 18. Changes in the color of the black display were measured in the same manner as in Example 18. Changes were small and substantially the same as those in the polarizing plate used in the commercially-available product.

### Comparative Example 1

### (Manufacture of a Liquid Crystal Display and Evaluation Thereof)

The temperature and humidity conditions and the humidity conditions of the moisture-proofed container were changed as described in Table 2. The polarizing plate 1 was housed in the same manner as in Example 14 and left for three days. The polarizing plate 1 was affixed to the panel through use of the liquid crystal cell used in Example 15, to thus manufacture the liquid crystal display. Changes in color which are the same as those described in Example 15 were measured. In every plate the amounts of changes were great, and the optical compensation function was insufficient.

### Example 24

### (Manufacture of the Polarizing Plate 12 and a Liquid Crystal Display and Evaluation Thereof)

### (Preparation of a Coating Liquid for Use with a Light Scattering Layer)

Fifty g of a mixture consisting of pentaerythritol triacrylate and pentaerythritol tetraacrylate (PETA manufactured by Nippon Kayaku Ltd.) was diluted with 38.5 g of toluene. Moreover, 2 g of a polymerization initiator (Irgacure 184, Civa Specialty Chemicals Ltd.) were further added to the mixture and agitated. The solution was applied and set upon exposure to X-radiation. The thus-obtained coating film has a refractive index of 1.51.

Crosslinked polystyrene particles (having a refractive index of 1.60; SX-350 manufactured by Soken Chemical & Engineering Co., Ltd.) having a mean particle size of 3.5 μm were dispersed for 20 minutes at 10000 r.p.m. by means of a polytron disperser, to thus prepare 30% toluene dispersion. Subsequently, 1.7 g of the toluene dispersion and 13.3 g of 30% toluene dispersion consisting of crosslinked acrylic styrene particles having a mean particle size of 3.5 μm were added to the solution. Finally, 0.75 g of fluorine-based surface modifier (FP-1) and 10 g of silane coupling agent (KBM-5103 manufactured by Shin-Etsu Chemical Co., Ltd.) were added to the solution, thereby preparing a final solution.

The mixture was filtrated by a polypropylene filter having a pore size of 30 μm, to thus prepare a coating fluid for a light scattering layer.

### (Preparation of a Coating Liquid for Use with a Lower Refractive Layer)

Thirteen g of thermally-crosslinked fluorine polymer having a refractive index of 1.42 (JN-7228, a solid content of 6% manufactured by JSR Co., Ltd.), 1.3 g of silica sol (silica and MEK-ST particles have different sizes; a mean particle size of 45 nm, a solid content of 30% manufactured by Nissan Chemical Co., Ltd.), 0.6 g of a sol solution “a,” 5 g of methylethylketone, and 0.6 g of cyclohexane were added. After having been agitated, the mixture was filtrated by the polypropylene filter having a pore size of 1 μm, to thus prepare a coating fluid for a lower refractive layer.

### (Preparation of Transparent Protective Film with an Antireflective Layer)

A triacetylcellulose film having a thickness of 80 μm (TAC-TD80U manufactured by Fuji Photo Film Ltd.) was fed in the form of a roll. The coating fluid for the functional layer (the light scattering layer) was coated under predetermined requirements; that is, a gravure roll cycle of 30 r.p.m. and a transportation speed of 30 m/min., through use of a micro gravure roller of 50 mm in diameter with a gravure pattern having 180 lines/inch and a depth of 40 μm and a doctor blade. After having been dried at 60° C. for 150 seconds, the coating fluid was exposed to UV-radiation at an illuminance of 400 mW/cm² and a dosage of 250 mJ/cm² under nitrogen purging through use of an air-cooling metal halide lamp of 160 W/cm (manufactured by Eyegraphics Co., Ltd.), to thus set the coating layer and form a functional layer having a thickness of 6 μm. This layer was taken up.

The triacetylcellulose film coated with the functional layer (the light scattering layer) was again taken up.

The prepared coating fluid for the lower refractive layer was coated under predetermined requirements; that is, a gravure roll cycle of 30 r.p.m. and a transportation speed of 15 m/min., through use of the micro gravure roller of 50 mm diameter with a gravure pattern having 180 lines/inch and a depth of 40 μm and the doctor blade. After having been dried at 120° C. for 150 seconds, the coating fluid was further dried at 140° for 8 minutes. The fluid was then exposed to UV-radiation at an illuminance of 400 mW/cm² and a dosage of 900 mJ/cm² under nitrogen purging through use of an air-cooling metal halide lamp of 240 W/cm (manufactured by Eyegraphics Co., Ltd.), to thus set the coating layer and form a functional layer having a thickness of 100 nm. Thus-prepared film was taken up.

### (Manufacture of a Polarizing Plate 13)

Iodine was caused to adhere to the flow-cast polyvinyl alcohol film, to thus manufacture a polarizing film.

The thus-formed transparent protective film with the antireflective film was saponified in the same manner as in Example 12, and the film was affixed to one side of the polarizing film through use of the polyvinyl-alcohol-based adhesive. The cellulose acetate film manufactured in Example 1 was saponified in the same manner as in Example 12, and the film was affixed to the remaining side of the polarizing film through use of the polyvinyl-alcohol-based adhesive.

The transmission axis of the polarizing film was arranged in parallel with the lagging axis of the cellulose acetate film manufactured in Example 1. The transmission axis of the polarizing film was arranged so as to cross at right angles the lagging axis of the commercially-available cellulose acetate film. Thus, the polarizing plate 13 was manufactured.

The spectral reflection factor in the wavelength range of 380 to 780 nm at an incident angle of 5° was measured through use of a spectrophotometer (manufactured by Nihon Bunko Co. Ltd.), and an integrating sphere average reflectivity of 450 to 650 nm was determined. The reflectivity was 2.3%.

The polarizing plate was housed in the moisture-proofed container for three days as in Example 14, except that requirements for humidity conditioning had been changed in advance to a condition described in Table 2. The polarizing plate 1 manufactured in Example 12 was also subjected to the same treatment.

The polarizing plate 13 was affixed to one side of the liquid crystal cell manufactured in Example 14, and the polarizing plate 1 was affixed to the other surface, to thus manufacture a liquid crystal display. Changes in the color of the black display of the thus-manufacture liquid crystal display were measured in the same manner as in Example 14. Differences between the initial values and the measured values were determined. As a result, changes in all of the polarizing plates were found to be small and substantially the same as those in the polarizing plate used in the commercially-available product.

TABLE 2

| | | Conditions during | | Internal | | Conditions for affixing the | | Change in black |
|---|---|---|---|---|---|---|---|---|
| | | wrapping | | conditions of bag | | polarizing plate to the cell | | color |
| | Polarizing Plate | Temperature | Humidity | Temperature | Humidity | Temperature | Humidity | (ΔE*) |
| Example 14 | Polarizing Plate 1 | 25° C. | 60% RH | 25° C. | 55% RH | 25° C. | 60% RH | 0.007 |
| Example 15 | Polarizing Plate 2 | 25° C. | 65% RH | 25° C. | 57% RH | 25° C. | 60% RH | 0.009 |
| Example 16 | Polarizing Plate 3 | 25° C. | 30% RH | 25° C. | 45% RH | 25° C. | 60% RH | 0.008 |
| Example 17 | Polarizing Plate 4 | 25° C. | 80% RH | 25° C. | 63% RH | 25° C. | 60% RH | 0.006 |
| Example 18 | Polarizing Plate 5 | 25° C. | 60% RH | 25° C. | 55% RH | 25° C. | 60% RH | 0.002 |
| | Polarizing Plate 12 | 25° C. | 60% RH | 25° C. | 55% RH | 25° C. | 60% RH | |
| | Polarizing Plate 6 | 25° C. | 60% RH | 25° C. | 55% RH | 25° C. | 60% RH | 0.002 |
| | Polarizing Plate 12 | 25° C. | 60% RH | 25° C. | 55% RH | 25° C. | 60% RH | |
| Example 19 | Polarizing Plate 7 | 25° C. | 60% RH | 25° C. | 55% RH | 25° C. | 50% RH | 0.007 |
| Example 20 | Polarizing Plate 8 | 25° C. | 60% RH | 25° C. | 55% RH | 25° C. | 60% RH | 0.006 |
| | Polarizing Plate 12 | 25° C. | 60% RH | 25° C. | 55% RH | 25° C. | 60% RH | |
| Example 21 | Polarizing Plate 9 | 25° C. | 60% RH | 25° C. | 55% RH | 25° C. | 60% RH | 0.007 |
| | Polarizing Plate 12 | 25° C. | 60% RH | 25° C. | 55% RH | 25° C. | 60% RH | |
| Example 22 | Polarizing Plate 10 | 25° C. | 55% RH | 25° C. | 45% RH | 25° C. | 60% RH | 0.008 |
| | Polarizing Plate 12 | 25° C. | 55% RH | 25° C. | 45% RH | 25° C. | 60% RH | |
| Example 23 | Polarizing Plate 11 | 25° C. | 55% RH | 25° C. | 45% RH | 25° C. | 60% RH | 0.008 |
| | Polarizing Plate 12 | 25° C. | 55% RH | 25° C. | 45% RH | 25° C. | 60% RH | |
| Example 24 | Polarizing Plate 13 | 25° C. | 44% RH | 25° C. | 50% RH | 25° C. | 50% RH | 0.005 |
| Comparative Example 1 | Polarizing Plate 1 | 25° C. | 20% RH | 25° C. | 41% RH | 25° C. | 60% RH | 0.021 |
| | | 25° C. | 10% RH | 25° C. | 37% RH | 25° C. | 60% RH | 0.032 |
| | | 25° C. | 95% RH | 25° C. | 70% RH | 25° C. | 50% RH | 0.024 |

| | | | | | | | |
|---|---|---|---|---|---|---|---|
| Commercially-Available | — | — | — | — | — | — | 0.007 |

### INDUSTRIAL APPLICABILITY

An polarizing plate according to the present invention can be used as displays such as LCD, which is less susceptible to changes in view-angle characteristic.

This application is based on Japanese Patent Application Nos. JP2003-430718 and JP2004-213205, filed on Dec. 25, 2003 and Jul. 21, 2004, respectively, the contents of which is incorporated herein by reference.

1. A polarizing plate housed in a moisture-proofed container, which comprises a transparent protective film comprising a cellulose acylate film, wherein Re(λ) and Rth(λ) defined by formulae (I) and (II) satisfies formulae (III) and (IV),
wherein
a humidity in the moisture-proofed container is from 40% RH to 65% RH at 25° C.:
Re(λ)=(nx−ny)×d (I)
Rth(λ)={(nx+ny)/2−nz}×d (II)
30≦Re(590)≦200 (III)
70≦Rth(590)≦400 (IV)
wherein Re(λ) is a retardation value by nm in a film plane of the cellulose acylate film with respect to a light having a wavelength of λnm;
Rth(λ) is a retardation value by nm in a direction of thickness of the cellulose acylate film with respect to the light having the wavelength of λ nm;
nx is a refraction index in a slow axis direction in the film plane;
ny is a refractive index in a fast axis direction in the film plane;
nz is a refraction index in the direction perpendicular the film plane; and
d is a thickness of the cellulose acylate film.

2. A polarizing plate housing in a moisture-proofed container, which comprises a transparent protective film comprising a cellulose acylate film, wherein Re(λ) and Rth(λ) defined by formulae (I) and (II) satisfies formulae (III) and (IV),
wherein
a first humidity in the moisture-proofed container is within a range of ±15% RH with respect to a second humidity, when the polarizing plate is stuck to a liquid crystal cell at the second humidity:
Re(λ)=(nx−ny)×d (I)
Rth(λ)={(nx+ny)/2−nz}×d (II)
30≦Re(590)≦200 (III)
70≦Rth(590)≦400 (IV)
wherein Re(λ) is a retardation value by nm in a film plane of the cellulose acylate film with respect to a light having a wavelength of λ nm;
Rth(λ) is a retardation value by nm in a direction perpendicular the film plane with respect to the light having the wavelength of λ nm;
nx is a refraction index in a slow axis direction in the film plane;
ny is a refraction index in a fast axis direction in the film plane;
nz is a refraction index in the direction perpendicular the film plane; and
d is a thickness of the cellulose acylate film.

3. The polarizing plate according to claim 1, wherein the cellulose acylate film satisfies formula (V):
230≦Rth(590)≦300. (V)

4. The polarizing plate according to claim 1, wherein the cellulose acylate film comprises a cellulose acylate in which a hydroxyl group of a cellulose is substituted by at least one of an acetyl group and an acyl group having 3 to 22 carbon atoms; and
a substitution degree A of the acetyl group and a substitution degree B of the acyl group having 3 to 22 carbon atoms satisfy formula (VI):
2.0≦A+B≦3.0. (VI)

5. The polarizing plate according to claim 4, wherein the acyl group having 3 to 22 carbon atoms comprises at least one of a butanoyl group and a propionyl group.

6. The polarizing plate according to claim 1, wherein the cellulose acylate film comprises a cellulose acylate in which a total substitution degree of a hydroxyl group at sixth position of a cellulose is 0.75 or more.

7. The polarizing plate according to claim 1, wherein the cellulose acylate film comprises a retardation-developing agent comprising at least one of a rod-like compound and a discotic compound.

8. The polarizing plate according to claim 1, wherein the cellulose acylate film comprises at least one of a plasticizer, an ultraviolet absorber, and a parting agent.

9. The polarizing plate according to claim 1, wherein the cellulose acylate film has a thickness of 40 to 110 μm.

10. The polarizing plate according to claim 1, wherein the cellulose acylate film has a glass transition temperature Tg of 70 to 135° C.

11. The polarizing plate according to claim 1, wherein the cellulose acylate film has an elastic modulus of 1500 to 5000 MPa.

12. The polarizing plate according to claim 1, wherein the cellulose acylate film has an equilibrium moisture content of 3.2% or less at 25° C. and 80% RH.

13. The polarizing plate according to claim 1, wherein the cellulose acylate film has a water vapor permeability of 300 g/m²·24 hr to 1000 g/m²·24 hr in terms of a film thickness of 80 μm under a condition of 40° C. and 90% RH for 24 hours.

14. The polarizing plate according to claim 1, wherein the cellulose acylate film has a haze of 0.01 to 2%.

15. The polarizing plate according to claim 1, wherein the cellulose acylate film comprises a silicon dioxide particle having an average secondary particle size of 0.2 to 1.5 μm.

16. The polarizing plate according to claim 1, wherein the cellulose acylate film has a photoelastic coefficient of 50×10⁻¹³ cm²/dyne or less.

17. The polarizing plate according to claim 1, which comprises at least one of a hard coating layer, an antiglare layer.

18. A liquid crystal display comprising a polarizing plate according to claim 1.

19. A liquid crystal display comprising:
a liquid crystal cell of an OCB-mode or a VA-mode; and
a polarizing plate according to claim 1 on each of upper and lower sides of the liquid crystal cell.

20. A liquid crystal display comprising:
a liquid crystal cell of a VA-mode;
a back light; and
a polarizing plate according to claim 1 between the liquid crystal cell and the back light.

21. A moisture-proofed container housing a polarizing plate, which has a internal humidity of 40% RH to 65% at 25° C.,
wherein the polarizing plate comprises a transparent protective film comprising a cellulose acylate film, wherein Re(λ) and Rth(λ) defined by formulae (I) and (II) satisfies formulae (III) and (IV):
Re(λ)=(nx−ny)×d (I)
Rth(λ)={(nx+ny)/2−nz}×d (II)
30≦Re(590)≦200 (III)
70≦Rth(590)≦400 (IV)
wherein RE(λ) is a retardation value by nm in a film plane of the cellulose acylate film with respect to a light having a wavelength of λ nm;
Rth(λ) is a retardation value by nm in a direction of thickness of the cellulose acylate film with respect to the light having the wavelength of λ nm;
nx is a refractive index in a slow axis direction in the film plane;
ny is a refractive index in a fast axis direction in the film plane;
nz is a refractive index in the direction perpendicular the film plane; and
d is a thickness of the cellulose acylate film.

22. The moisture-proofed container according to claim 21, which comprises a material having a water vapor permeability of 30 g/m²·24 hr or less under a condition of 40° C. and 90% RH for 24 hours.

23. The moisture-proofed container according to claim 21, which comprises a plastic film having a ceramics layer.

24. The moisture-proofed container according to claim 21, which comprises a plastic film and an aluminum foil.

25. A method for storing a polarizing plate, which comprises housing the polarizing plate in a moisture-proofed container having a internal humidity of 40% RH to 65% RH at 25° C.,
wherein the polarizing plate comprises a transparent protective film comprising a cellulose acylate film, wherein RE(λ) and Rth(λ) defined formulae (I) and (II) satisfies formulae (III) and (IV):
Re(λ)=(nx−ny)×d (I)
Rth(λ)={(nx+ny)/2−nz}×d (II)
30≦Re(590)≦200 (III)
70≦Rth(590)≦400 (IV)
wherein Re(λ) is a retardation value by nm in a film plane of the cellulose acylate film with respect to a light having a wavelength of λ nm;
Rth(λ) is a retardation value by nm in a direction of thickness of the cellulose acylate film with respect to the light having the wavelength of λ nm;
nx is a refractive index in a slow axis direction in the film plane;
ny is a refractive index in a fast axis direction in the film plane;
nz is a refractive index in the direction perpendicular the film plane; and
d is a thickness of the cellulose acylate film.

26. A method for producing a liquid crystal display, which comprises:
storing a polarizing plate at a first humidity; and
sticking the polarizing plate to a liquid crystal cell at a second humidity,
wherein
the first humidity is within a range of ±15% RH with respect to the second humidity; and
the polarizing plate comprises a transparent protective film comprising a cellulose acylate film, wherein RE(λ) and Rth(λ) defined by formulae (I) and (II) satisfies formulae (III) and (IV):
Re(λ)=(nx−ny)×d (I)
Rth(λ)={(nx+ny)/2−nz}×d (II)
30≦Re(590)≦200 (III)
70≦Rth(590)≦400 (IV)
wherein Re(λ) is a retardation value by nm in a film plane of the cellulose acylate film with respect to a light having a wavelength of λ nm;
Rth(λ) is a retardation value by nm in a direction of thickness of the cellulose acylate film with respect to the light having the wavelength of λ nm;
nx is a refractive index in a slow axis direction in the film plane;
ny is a refractive index in a fast axis direction in the film plane;
nz is a refractive index in the direction perpendicular the film plane; and
d is a thickness of the cellulose acylate film. _
